(19) United States
(12) Patent Application Publication
(10) Pub. No.: US 2026/0099592 A1
(43) Pub. Date: Apr. 9, 2026

(54) SECURITY ACTION BASED ON AN AI-DETERMINED INTENT AND/OR IMPACT OF A RESOURCE IN AN ENTERPRISE

(71) Applicant: Microsoft Technology Licensing, LLC, Redmond, WA (US)

(72) Inventors: Amir PIROGOVSKY, Tel-Aviv (IL); Doron BAR SHALOM, Le Mont-Sur-Lausanne (CH); Fady COPTY, Haifa (IL); Amir Berko SCHWARTZ, Kiryat Ono (IL)

(21) Appl. No.: 18/905,916

(22) Filed: Oct. 3, 2024

(51) Int. Cl. G06F 21/55

(52) U.S. Cl. CPC G06F 21/554; G06F 2221/034

(57) ABSTRACT

Techniques are described herein that are capable of performing a security action based on an AI-determined intent and/or impact of a resource in an enterprise. A security alert regarding an identified resource of an enterprise is received. Intents of subsets of information regarding a software application utilized by the enterprise are determined using an AI model. The intents are mapped to subsets of resources in the enterprise and/or the AI model is used to determine impacts of the subsets of the resources on the enterprise. In response to the security alert, a security action is performed with regard to the identified resource as a result of an intent and/or impact associated with the identified resource satisfying an action criterion associated with the security action.

### BACKGROUND

When a security alert is received by a security professional in an enterprise environment, the security professional determines a type of security action (if any) that is warranted by the security alert. The security professional often reviews available information to make an informed decision. However, the available information may be quite limited, and the type of security action that is performed by the security professional may have unintended negative consequences for the enterprise. For instance, performing the security action may cause important (e.g., business-critical) systems to be taken offline or important users (e.g., customers) to lose access to such systems. Determining the possible negative consequences that may result from performing a security action typically involves the security professional manually analyzing the systems in the enterprise. However, manually analyzing the systems often is costly and consumes a substantial amount of the security professional’s time, which may lead the security professional to implement a default position in which no security action is performed.

### SUMMARY

Artificial intelligence (AI) is intelligence of a machine (e.g., a computing system) and/or code (e.g., software and/or firmware), as opposed to intelligence of a living creature (e.g., a human). An AI prompt indicates (e.g., specifies) a task that is to be performed by an AI model. Examples of an AI prompt include but are not limited to a zero-shot prompt, a one-shot prompt, and a few-shot prompt. A zero-shot prompt is a prompt for which the prompt and/or its corresponding contextual information, which are to be processed by the AI model, is not included in pre-trained knowledge of the AI model. A one-shot prompt is a prompt that includes a target prompt along with a single example prompt and a single example answer that is responsive to the single example prompt. The example prompt and the example answer provide guidance as to how the AI model is expected to respond to the target prompt. A few-shot prompt is a prompt that includes a target prompt along with multiple example prompts and multiple example answers that are responsive to the respective example prompts. The example prompts and the example answers provide guidance as to how the AI model is expected to respond to the target prompt.

An AI prompt may be a natural language prompt. A natural language prompt is a prompt that is written in a natural language. A natural language is a human language that has developed through use and repetition. For instance, the natural language may have developed naturally without conscious planning or premeditation. Examples of a natural language include English, French, Spanish, and Mandarin. In an aspect, the natural language prompt is generated by a user (e.g., a human). In another aspect, the natural language prompt is generated by a computing system (e.g., an AI assistant that runs on the computing system).

An AI prompt may not be written in a natural language. For instance, the AI prompt may include (e.g., be) computer code. The AI prompt may be any suitable sequence of characters that is capable of being interpreted by an AI model.

An AI model is a model that utilizes artificial intelligence to generate an answer that is responsive to an AI prompt (a.k.a. prompt) that is received by the AI model. The AI model may be an artificial general intelligence model. An artificial general intelligence model is an AI model (e.g., an autonomous AI model) that is configured to be capable of performing any task that an intelligent being (e.g., a human) is capable of performing. In an example implementation, the artificial general intelligence model is capable of performing a task that surpasses the capabilities of an animal.

An enterprise is an organization that uses an information technology infrastructure to manage and/or support operations of the organization. The information technology infrastructure includes resources that are capable of facilitating management and/or support of the operations. For instance, each resource may perform a respective aspect of the management and/or the support of one or more of the operations. Each resource may be a physical resource or a virtual resource. Examples of a resource include but are not limited to an account (e.g., a subscription to a service), a virtual machine, a physical machine (e.g., a physical computing system), a store (e.g., data storage or a code repository), an identity (e.g., a user identity), a user, a secret, a cluster (e.g., a Kubernetes® cluster), a process running on a machine, a network, a file, a folder, or a resource group (e.g., a collection of resources of a particular type). Accordingly, it will be recognized that a resource may be implemented in software, firmware, hardware, or any combination thereof. A Kubernetes® cluster is a plurality of node machines that are used to run containerized software application(s). The node machines may include one or more physical machines and/or one or more virtual machines. In an aspect, the Kubernetes® cluster automates distribution of the containerized software application(s) across the plurality of node machines, manages scaling and failover, and/or provides deployment patterns and services for managing the containerized software application(s).

A security graph is a graph that represents an information technology infrastructure of an enterprise. A graph is a mathematical structure that includes nodes (a.k.a. vertices) and edges (a.k.a. links) to model relationships (e.g., pairwise relationships) between objects. Each node in the security graph represents a respective resource in the information technology infrastructure of the enterprise. Accordingly, the nodes in the security graph are commonly referred to as “resource nodes.” Each edge in the security graph represents a relationship between first and second nodes in a pair of the nodes that are included in the security graph.

A security alert is an alert indicating that a resource is potentially a target of a cyberattack. The security alert may be triggered by a misconfiguration of the resource or a system via which the resource is accessible or by an unexpected, highly impactful, or rare activity being performed with regard to the resource or the system. For instance, a threat actor may exploit a vulnerability of the resource or the system to perpetuate the cyberattack. Examples of a cyberattack include but are not limited to a denial of service (DoS) attack, a distributed DoS (DDoS) attack, a man-in-the-middle (MITM) attack, a malware attack, a phishing attack, a ransomware attack, and a cross-site scripting (XSS) attack. A DoS attack is an attack that renders a system unable to respond to a legitimate service request by overwhelming resource(s) of the system. A DDoS attack is similar to a DoS attack but involves multiple (e.g., a vast array) malware-infected hosts that are controlled by the threat actor to cause resource exhaustion. An MITM attack is an attack that enables the threat actor to eavesdrop on data exchanged between multiple entities (e.g., people, networks, or computers). A malware attack is an attack in which malicious software is introduced (e.g., injected) to a system to damage the system and/or to steal information from the system. A phishing attack is an attack in which a deceptive communication (e.g., an electronic mail (a.k.a. email) message) is provided to an entity to trick the entity into revealing sensitive information or into downloading malware. A ransomware attack is an attack that encrypts file(s) and/or system(s) and demands payment (a.k.a. a ransom) for decryption. An XSS attack exploits a vulnerability of a web application to introduce a malicious script into a web page that is viewed by other users.

A security action is an action that is performed in response to (e.g., to address) a security alert. For instance, performance of the security action may be triggered by the security alert. In an aspect, the security action is configured to increase security of an enterprise (e.g., a resource in an information technology infrastructure of the enterprise). Examples of a security action include but are not limited to isolating a machine, containing (e.g., quarantining) a user, containing an account, containing a file, containing a folder, stopping a virtual machine, and rotating (e.g., changing) a secret (e.g., a password, an application programming interface (API) key, an encryption key, or other credential).

It may be desirable to use an AI model to increase an amount of information that is available for determining a security action that is to be performed in response to a security alert regarding a resource in an information technology infrastructure of an enterprise. The security action may be determined by mapping a resource node, which represents the resource in a security graph, to relevant information (e.g., source code management file(s), documentation, and/or communication(s)) and to base selection of the security action at least partially on a summary of the relevant information. For instance, the relevant information may provide insight that is not available from a conventional security graph. The insight may indicate an intent (e.g., a purpose or a functionality) of the resource and/or an intent of a software application that utilizes (e.g., relies on) the resource, an intent of the relevant information with regard to the software application, and so on. For example, the software application may be utilized by the enterprise to manage or support operation(s) of the enterprise. By having the insight from the relevant information, extents to which available security actions are capable of negatively affecting the enterprise may be determined. A desired security action may be selected from the available security actions as a result of the extent to which the desired security action is capable of negatively affecting the enterprise satisfying a criterion (e.g., being less than or equal to a threshold extent).

Various approaches are described herein for, among other things, performing a security action based on an AI-determined intent and/or impact of a resource in an enterprise. In a first example approach, a security alert regarding an identified resource in an information technology infrastructure of an enterprise is received. Intents of subsets of files in a source code management system regarding a software application that is utilized by the enterprise are determined using an AI model by causing the AI model to analyze contents of the files. The intents are mapped to subsets of resources in the information technology infrastructure based at least on a mapping of the subsets of the files to the subsets of the resources. In response to the security alert, execution of an instruction is triggered as a result of an identified intent that is mapped to the identified resource satisfying an action criterion associated with a designated security action. Triggering the execution of the instruction causes the designated security action to be performed with regard to the identified resource. The designated security action is performed by selecting the designated security action from a plurality of security actions.

In a second example approach, a security alert regarding an identified resource in an information technology infrastructure of an enterprise is received. First intents of subsets of information regarding a software application that is utilized by the enterprise are determined using an AI model by causing the AI model to analyze the information. The subsets of the information include subsets of documentation regarding the software application and/or subsets of communications regarding the software application. Impacts of subsets of resources in the information technology infrastructure on the enterprise are determined using the AI model by causing the AI model to analyze the subsets of the information based at least on the first intents of the subsets of the information corresponding to second intents of the subsets of the resources. In response to the security alert, execution of an instruction is triggered as a result of an identified impact of a subset of resources that includes the identified resource satisfying an action criterion associated with a designated security action. Triggering the execution of the instruction causes the designated security action to be performed with regard to the identified resource. The designated security action is performed by selecting the designated security action from a plurality of security actions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURESE

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example AI-assisted security action system in accordance with an embodiment.

FIG. 2 depicts a flowchart of an example method for performing a security action based on an AI-determined intent of a resource in an enterprise in accordance with an embodiment.

FIG. 3 is a block diagram of an example computing system in accordance with an embodiment.

FIG. 4 depicts a flowchart of an example method for performing a security action based on an AI-determined impact of a resource in an enterprise in accordance with an embodiment.

FIG. 5 is a block diagram of another example computing system in accordance with an embodiment.

FIG. 6 is a system diagram of an example mobile device in accordance with an embodiment.

FIG. 7 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

Artificial intelligence (AI) is intelligence of a machine (e.g., a computing system) and/or code (e.g., software and/or firmware), as opposed to intelligence of a living creature (e.g., a human). An AI prompt indicates (e.g., specifies) a task that is to be performed by an AI model. Examples of an AI prompt include but are not limited to a zero-shot prompt, a one-shot prompt, and a few-shot prompt. A zero-shot prompt is a prompt for which the prompt and/or its corresponding contextual information, which are to be processed by the AI model, is not included in pre-trained knowledge of the AI model. A one-shot prompt is a prompt that includes a target prompt along with a single example prompt and a single example answer that is responsive to the single example prompt. The example prompt and the example answer provide guidance as to how the AI model is expected to respond to the target prompt. A few-shot prompt is a prompt that includes a target prompt along with multiple example prompts and multiple example answers that are responsive to the respective example prompts. The example prompts and the example answers provide guidance as to how the AI model is expected to respond to the target prompt.

An AI prompt may be a natural language prompt. A natural language prompt is a prompt that is written in a natural language. A natural language is a human language that has developed through use and repetition. For instance, the natural language may have developed naturally without conscious planning or premeditation. Examples of a natural language include English, French, Spanish, and Mandarin. In an aspect, the natural language prompt is generated by a user (e.g., a human). In another aspect, the natural language prompt is generated by a computing system (e.g., an AI assistant that runs on the computing system).

An AI prompt may not be written in a natural language. For instance, the AI prompt may include (e.g., be) computer code. The AI prompt may be any suitable sequence of characters that is capable of being interpreted by an AI model.

An AI model is a model that utilizes artificial intelligence to generate an answer that is responsive to an AI prompt (a.k.a. prompt) that is received by the AI model. The AI model may be an artificial general intelligence model. An artificial general intelligence model is an AI model (e.g., an autonomous AI model) that is configured to be capable of performing any task that an intelligent being (e.g., a human) is capable of performing. In an example implementation, the artificial general intelligence model is capable of performing a task that surpasses the capabilities of an animal.

An enterprise is an organization that uses an information technology infrastructure to manage and/or support operations of the organization. The information technology infrastructure includes resources that are capable of facilitating management and/or support of the operations. For instance, each resource may perform a respective aspect of the management and/or the support of one or more of the operations. Each resource may be a physical resource or a virtual resource. Examples of a resource include but are not limited to an account (e.g., a subscription to a service), a virtual machine, a physical machine (e.g., a physical computing system), a store (e.g., data storage or a code repository), an identity (e.g., a user identity), a user, a secret, a cluster (e.g., a Kubernetes® cluster), a process running on a machine, a network, a file, a folder, or a resource group (e.g., a collection of resources of a particular type). Accordingly, it will be recognized that a resource may be implemented in software, firmware, hardware, or any combination thereof. A Kubernetes® cluster is a plurality of node machines that are used to run containerized software application(s). The node machines may include one or more physical machines and/or one or more virtual machines. In an aspect, the Kubernetes® cluster automates distribution of the containerized software application(s) across the plurality of node machines, manages scaling and failover, and/or provides deployment patterns and services for managing the containerized software application(s).

A security graph is a graph that represents an information technology infrastructure of an enterprise. A graph is a mathematical structure that includes nodes (a.k.a. vertices) and edges (a.k.a. links) to model relationships (e.g., pairwise relationships) between objects. Each node in the security graph represents a respective resource in the information technology infrastructure of the enterprise. Accordingly, the nodes in the security graph are commonly referred to as “resource nodes.” Each edge in the security graph represents a relationship between first and second nodes in a pair of the nodes that are included in the security graph.

A security alert is an alert indicating that a resource is potentially a target of a cyberattack. The security alert may be triggered by a misconfiguration of the resource or a system via which the resource is accessible or by an unexpected, highly impactful, or rare activity being performed with regard to the resource or the system. For instance, a threat actor may exploit a vulnerability of the resource or the system to perpetuate the cyberattack. Examples of a cyberattack include but are not limited to a denial of service (DoS) attack, a distributed DoS (DDoS) attack, a man-in-the-middle (MITM) attack, a malware attack, a phishing attack, a ransomware attack, and a cross-site scripting (XSS) attack. A DoS attack is an attack that renders a system unable to respond to a legitimate service request by overwhelming resource(s) of the system. A DDoS attack is similar to a DoS attack but involves multiple (e.g., a vast array) malware-infected hosts that are controlled by the threat actor to cause resource exhaustion. An MITM attack is an attack that enables the threat actor to eavesdrop on data exchanged between multiple entities (e.g., people, networks, or computers). A malware attack is an attack in which malicious software is introduced (e.g., injected) to a system to damage the system and/or to steal information from the system. A phishing attack is an attack in which a deceptive communication (e.g., an electronic mail (a.k.a. email) message) is provided to an entity to trick the entity into revealing sensitive information or into downloading malware. A ransomware attack is an attack that encrypts file(s) and/or system(s) and demands payment (a.k.a. a ransom) for decryption. An XSS attack exploits a vulnerability of a web application to introduce a malicious script into a web page that is viewed by other users.

A security action is an action that is performed in response to (e.g., to address) a security alert. For instance, performance of the security action may be triggered by the security alert. In an aspect, the security action is configured to increase security of an enterprise (e.g., a resource in an information technology infrastructure of the enterprise). Examples of a security action include but are not limited to isolating a machine, containing (e.g., quarantining) a user, containing an account, containing a file, containing a folder, stopping a virtual machine, and rotating (e.g., changing) a secret (e.g., a password, an application programming interface (API) key, an encryption key, or other credential).

It may be desirable to use an AI model to increase an amount of information that is available for determining a security action that is to be performed in response to a security alert regarding a resource in an information technology infrastructure of an enterprise. The security action may be determined by mapping a resource node, which represents the resource in a security graph, to relevant information (e.g., source code management file(s), documentation, and/or communication(s)) and to base selection of the security action at least partially on a summary of the relevant information. For instance, the relevant information may provide insight that is not available from a conventional security graph. The insight may indicate an intent (e.g., a purpose or a functionality) of the resource and/or an intent of a software application that utilizes (e.g., relies on) the resource, an intent of the relevant information with regard to the software application, and so on. For example, the software application may be utilized by the enterprise to manage or support operation(s) of the enterprise. By having the insight from the relevant information, extents to which available security actions are capable of negatively affecting the enterprise may be determined. A desired security action may be selected from the available security actions as a result of the extent to which the desired security action is capable of negatively affecting the enterprise satisfying a criterion (e.g., being less than or equal to a threshold extent).

Example embodiments described herein are capable of performing a security action based on an AI-determined intent and/or impact of a resource in an enterprise. In a first example approach, a security alert regarding an identified resource in an information technology infrastructure of an enterprise is received. Intents of subsets of files in a source code management system regarding a software application that is utilized by the enterprise are determined using an AI model by causing the AI model to analyze contents of the files. The intents are mapped to subsets of resources in the information technology infrastructure based at least on a mapping of the subsets of the files to the subsets of the resources. In response to the security alert, execution of an instruction is triggered as a result of an identified intent that is mapped to the identified resource satisfying an action criterion associated with a designated security action. Triggering the execution of the instruction causes the designated security action to be performed with regard to the identified resource. The designated security action is performed by selecting the designated security action from a plurality of security actions.

In a second example approach, a security alert regarding an identified resource in an information technology infrastructure of an enterprise is received. First intents of subsets of information regarding a software application that is utilized by the enterprise are determined using an AI model by causing the AI model to analyze the information. The subsets of the information include subsets of documentation regarding the software application and/or subsets of communications regarding the software application. Impacts of subsets of resources in the information technology infrastructure on the enterprise are determined using the AI model by causing the AI model to analyze the subsets of the information based at least on the first intents of the subsets of the information corresponding to second intents of the subsets of the resources. In response to the security alert, execution of an instruction is triggered as a result of an identified impact of a subset of resources that includes the identified resource satisfying an action criterion associated with a designated security action. Triggering the execution of the instruction causes the designated security action to be performed with regard to the identified resource. The designated security action is performed by selecting the designated security action from a plurality of security actions.

Example techniques described herein have a variety of benefits as compared to conventional techniques for determining a security action that is to be performed in response to a security alert. For instance, the example techniques are capable of identifying negative consequences that may result from each of multiple security actions that are available to address the security alert. The example techniques are capable of identifying an extent to which the negative consequences that may result from each of the security actions are capable of negatively impacting an information technology infrastructure of an enterprise, any one or more resources in the information technology infrastructure, and/or a software application that is utilized by the enterprise (e.g., and that utilizes the resource(s)). By analyzing the negative consequences and corresponding extents for each of the security actions, the example techniques are capable of determining an extent to which each of the security actions is capable of negatively impacting a business of the enterprise. The security action that is to be performed in response to the security alert may be selected by weighing the negative consequences that are associated with each security action against the potential benefits associated with the respective security action. For example, the security action may be selected based on (e.g., based at least on) its potential benefits outweighing its negative consequences to an extent that is greater than the extents to which the potential benefits of the other security actions outweigh their negative consequences. In another example, the security action may be selected based on a magnitude (e.g., severity) of its negative consequences being less than the magnitudes of the negative consequences of the other security actions.

The example techniques are capable of increasing security of an information technology infrastructure of an enterprise, any one or more resources in the information technology infrastructure, and/or a software application that is utilized by the enterprise. For instance, the example techniques are capable of selecting a security action to be performed as a result of the security action providing greater security than the other security actions, the security action providing the greatest security subject to a magnitude of the negative consequences associated with the security action not exceeding a threshold, etc. The example techniques may increase the security by reducing a likelihood of a security professional to implement a default position in which no security action is performed. The example techniques may increase an accuracy, precision and/or reliability with which a statistically most appropriate (e.g., most beneficial or least harmful) security action is selected from the security actions that are available to be performed. The example techniques are capable of increasing a reliability of the software application that is utilized by the enterprise by ensuring that the magnitude of the negative consequences associated with the selected security action does not exceed the threshold. For instance, the example techniques may ensure that the negative consequences associated with the selected security action do not negatively affect the software program (e.g., accessibility, reliability, or performance of the software program) more than a designated extent.

The example techniques may reduce an amount of time and/or resources (e.g., processor cycles, memory, network bandwidth) that is consumed to determine a security action that is to be performed in response to a security alert regarding a resource in an information technology infrastructure of an enterprise. For instance, by increasing an amount of information that is available for making the determination, the example techniques may reduce the amount of time and/or resources that otherwise would have been consumed to obtain the information, to determine an intent thereof in context of the enterprise (e.g., an intent thereof with regard to a software application utilized by the enterprise), and/or an impact thereof on the enterprise. Example types of information include but are not limited to files in a source code management (SCM) system (e.g., in a code repository thereof), documentation regarding a software application utilized by the enterprise, and communications regarding the software application. The example techniques may automate selection of the security action that is to be performed in response to the security alert (e.g., by using artificial intelligence to determine intents and/or impacts of information in context of the enterprise). By reducing the amount of time and/or resources that is consumed by a computing system to determine the security action that is to be performed in response to the security alert, the efficiency of the computing system may be increased.

By reducing the amount of time that is consumed to determine the security action that is to be performed in response to the security alert, the example techniques may increase a user experience and/or efficiency of a security professional who manages security of the enterprise (e.g., security of the information technology infrastructure of the enterprise). The example techniques may reduce a number of tasks that are manually performed by the security professional by utilizing artificial intelligence and/or by automating selection of the security action that is to be performed. Reducing the number of tasks that are manually performed by the security professional may enable the security professional to focus on other tasks, which may increase the security of the enterprise. The example techniques may increase a user experience and/or efficiency of an end user who utilizes a software application of the enterprise, for example, by increasing security of the enterprise (e.g., security of the software application). The user experience and/or the efficiency of the security professional and/or the end user may be increased in other ways, as well. For example, the user experience and/or the efficiency may be increased through a more accurate, precise, and/or reliable determination of a most appropriate security action to be performed in response to the security alert.

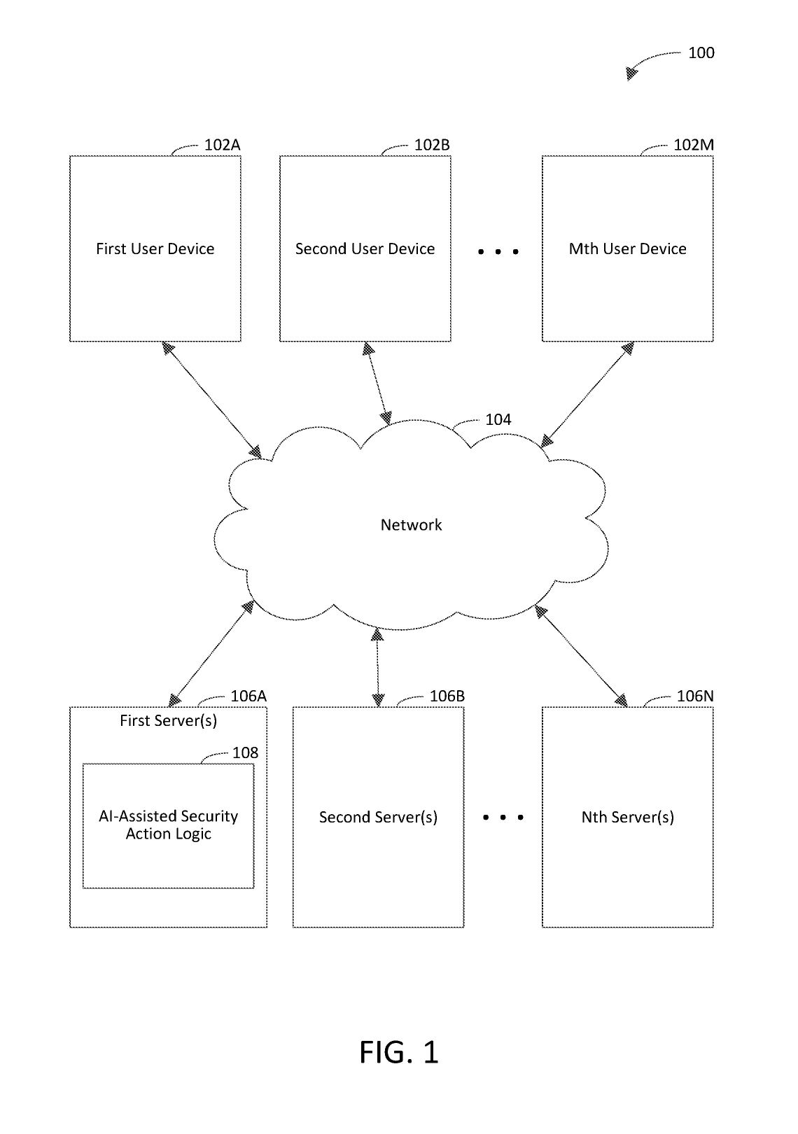

FIG. 1 is a block diagram of an example AI-assisted security action system 100 in accordance with an embodiment. Generally speaking, the AI-assisted security action system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the AI-assisted security action system 100 performs a security action based on an AI-determined intent and/or impact of a resource in an enterprise. Detail regarding techniques for performing a security action based on an AI-determined intent and/or impact of a resource in an enterprise is provided in the following discussion.

As shown in FIG. 1, the AI-assisted security action system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors, which may be on a same (e.g., single) device or distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the AI-assisted security action system 100.

One example type of computer program that may be executed by one or more of the servers 106A-106N is a computer security program. A computer security program is a computer program that provides security with regard to information and/or communications associated with a computing system. For instance, the information associated with the computing system may include information stored on the computing system and/or information accessed (e.g., read) by the computing system. The communications associated with the computing system may include communications received by the computing system and/or communications provided (e.g., transmitted) by the computing system. An example of a communication is an electronic message. Examples of a computer security program include Bitdefender® security program, developed and distributed by Bitdefender IPR Management Ltd.; Norton® security program, developed and distributed by Gen Digital Inc.; Avast® security program, developed and distributed by Avast Software S.R.O.; McAfee® security program, developed and distributed by McAfee, LLC; and Microsoft Defender® security program, developed and distributed by Microsoft Corporation. It will be recognized that the example techniques described herein may be implemented using a computer security program. For instance, a software product (e.g., a subscription service, a non-subscription service, or a combination thereof) may include the computer security program, and the software product may be configured to perform the example techniques, though the scope of the example embodiments is not limited in this respect.

The computer security program may be a cloud native application protection platform (CNAPP). A CNAPP is an all-in-one platform that unifies security and compliance capabilities to prevent, detect, and respond to cloud security threats. A CNAPP integrates multiple cloud security solutions, which traditionally have been siloed, into a common (e.g., single) user interface. The cloud security solutions may include cloud security posture management (CSPM), multipipeline development and operations (DevOps) security, a cloud workload protection platform (CWPP), cloud infrastructure entitlement management (CIEM), and cloud service network security (CSNS). CSPM provides a connected, prioritized view of potential vulnerabilities and misconfigurations across multi-cloud and hybrid environments. The CSPM continuously assesses overall security posture of a system and provides automated alerts and recommendations about critical issues that could expose the system to data breaches. The CSPM may include automated compliance management and remediation tools to identify and remedy compliance deficiencies. Multipipeline DevOps security provides a central console that enables management of DevOps security across multiple (e.g., all) pipelines. For instance, the multipipeline DevOps security may be used to reduce cloud misconfigurations and to scan new code to keep vulnerabilities therein from reaching a production environment. The multipipeline DevOps security may include infrastructure-as-code scanning tools that analyze configuration files from the earliest stages of development to confirm that new configuration files are compliant with security policies. A CWPP provides real-time detection and response to threats based on up-to-date information regarding multi-cloud workloads (e.g., virtual machines, containers, Kubernetes® pods and/or clusters, databases, storage accounts, network layers, and app services). The CWPP may enable a quick investigation into threats and reduce the attack surface of a system. CIEM centralizes permissions management across a cloud and hybrid footprint, which inhibits (e.g., prevents) accidental or malicious misuse of permissions. CSNS complements the CWPP by protecting cloud infrastructure in real time. The CSNS may include any of a variety of security tools, including but not limited to distributed denial-of-service protection, web application firewalls, transport layer security examination, and load balancing.

A computer security program may be incorporated into a cloud computing program (a.k.a. a cloud service). A cloud computing program is a computer program that provides hosted service(s) via a network (e.g., network 104). For instance, the hosted service(s) may be hosted by any one or more of the servers 106A-106N. The cloud computing program may enable users (e.g., at any of the user systems 102A-102M) to access shared resources that are stored on or are otherwise accessible to the server(s) via the network.

The cloud computing program may provide hosted service(s) according to any of a variety of service models, including but not limited to Backend as a Service (BaaS), Software as a Service (SaaS), Platform as a Service (PaaS), and Infrastructure as a Service (IaaS). BaaS enables applications (e.g., software programs) to use a BaaS provider’s backend services (e.g., push notifications, integration with social networks, and cloud storage) running on a cloud infrastructure. SaaS enables a user to use a SaaS provider’s applications running on a cloud infrastructure. PaaS enables a user to develop and run applications using a PaaS provider’s application development environment (e.g., operating system, programming-language execution environment, database) on a cloud infrastructure. IaaS enables a user to use an IaaS provider’s computer infrastructure (e.g., to support an enterprise). For example, IaaS may provide to the user virtualized computing resources that utilize the IaaS provider’s physical computer resources.

Examples of a cloud computing program include but are not limited to a Google Cloud® program developed and distributed by Google Inc.; an Oracle Cloud® program developed and distributed by Oracle Corporation; an Amazon Web Services® program developed and distributed by Amazon.com, Inc.; a Salesforce® program developed and distributed by Salesforce.com, Inc.; an AppSource® program developed and distributed by Microsoft Corporation; an Azure® program developed and distributed by Microsoft Corporation; a GoDaddy® program developed and distributed by GoDaddy.com LLC; and a Rackspace® program developed and distributed by Rackspace US, Inc. It will be recognized that the example techniques described herein may be implemented using a cloud computing program. For instance, a software product (e.g., a subscription service, a non-subscription service, or a combination thereof) may include the cloud computing program, and the software product may be configured to perform the example techniques, though the scope of the example embodiments is not limited in this respect.

The first server(s) 106A are shown to include AI-assisted security action logic 108 for illustrative purposes. The AI-assisted security action logic 108 is configured to perform a security action based on an AI-determined intent and/or impact of a resource in an enterprise. In an example implementation, the AI-assisted security action logic 108 receives a security alert regarding an identified resource in an information technology infrastructure of an enterprise. The AI-assisted security action logic 108 determines intents of subsets of files in a source code management system regarding a software application that is utilized by the enterprise using an AI model by causing the AI model to analyze contents of the files. The AI-assisted security action logic 108 maps the intents to subsets of resources in the information technology infrastructure based at least on a mapping of the subsets of the files to the subsets of the resources. In response to the security alert, the AI-assisted security action logic 108 triggers execution of an instruction as a result of an identified intent that is mapped to the identified resource satisfying an action criterion associated with a designated security action. Triggering the execution of the instruction causes the designated security action to be performed with regard to the identified resource. The designated security action is performed by selecting the designated security action from a plurality of security actions.

In another example implementation, the AI-assisted security action logic 108 receives a security alert regarding an identified resource in an information technology infrastructure of an enterprise. The AI-assisted security action logic 108 determines first intents of subsets of information regarding a software application that is utilized by the enterprise using an AI model by causing the AI model to analyze the information. The subsets of the information include subsets of documentation regarding the software application and/or subsets of communications regarding the software application. The AI-assisted security action logic 108 determines impacts of subsets of resources in the information technology infrastructure on the enterprise using the AI model by causing the AI model to analyze the subsets of the information based at least on the first intents of the subsets of the information corresponding to second intents of the subsets of the resources. In response to the security alert, the AI-assisted security action logic 108 triggers execution of an instruction as a result of an identified impact of a subset of resources that includes the identified resource satisfying an action criterion associated with a designated security action. Triggering the execution of the instruction causes the designated security action to be performed with regard to the identified resource. The designated security action is performed by selecting the designated security action from a plurality of security actions.

The AI-assisted security action logic 108 may be implemented in various ways to perform a security action based on an AI-determined intent and/or impact of a resource in an enterprise, including being implemented in hardware, software, firmware, or any combination thereof. For example, the AI-assisted security action logic 108 may be implemented as computer program code configured to be executed in one or more processors. In another example, at least a portion of the AI-assisted security action logic 108 may be implemented as hardware logic/electrical circuitry. For instance, at least a portion of the AI-assisted security action logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

It will be recognized that the AI-assisted security action logic 108 may be (or may be included in) a computer security program and/or a cloud computing program, though the scope of the example embodiments is not limited in this respect.

The AI-assisted security action logic 108 is shown to be incorporated in the first server(s) 106A for illustrative purposes and is not intended to be limiting. It will be recognized that the AI-assisted security action logic 108 (or any portion(s) thereof) may be incorporated in any one or more of the servers 106A-106N, any one or more of the user devices 102A-102M, or any combination thereof. For example, client-side aspects of the AI-assisted security action logic 108 may be incorporated in one or more of the user devices 102A-102M, and server-side aspects of AI-assisted security action logic 108 may be incorporated in one or more of the servers 106A-106N.

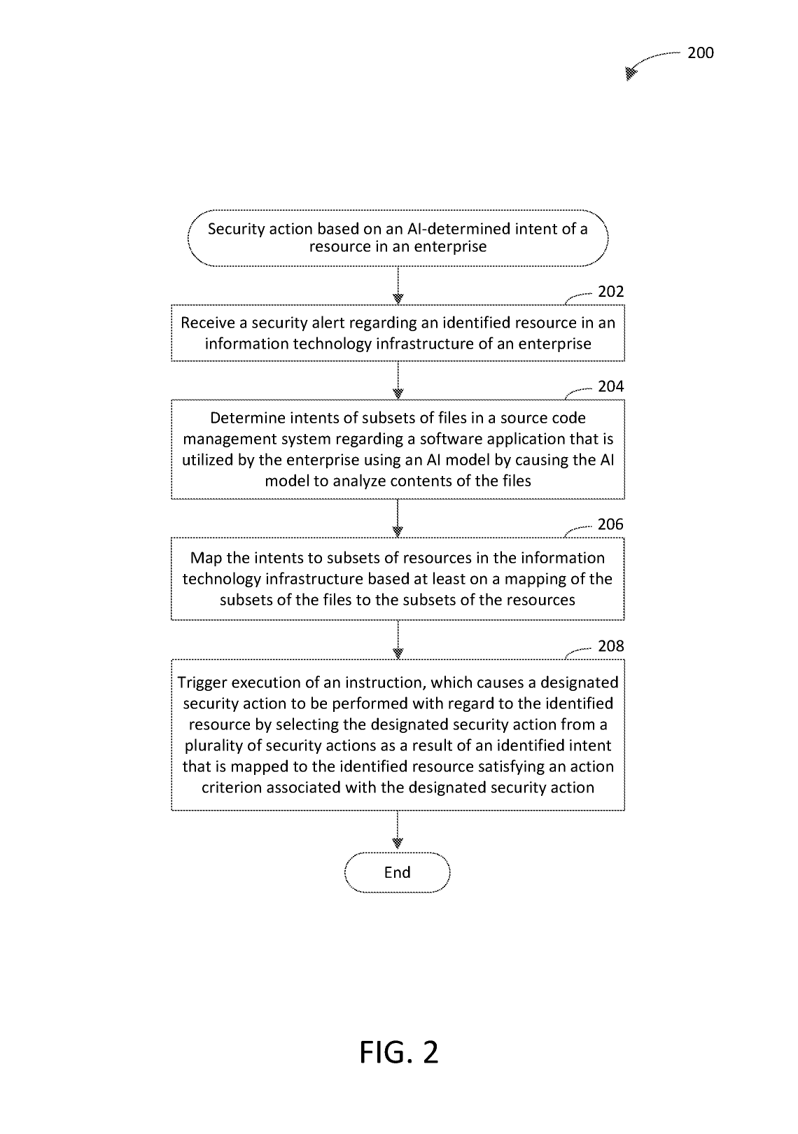

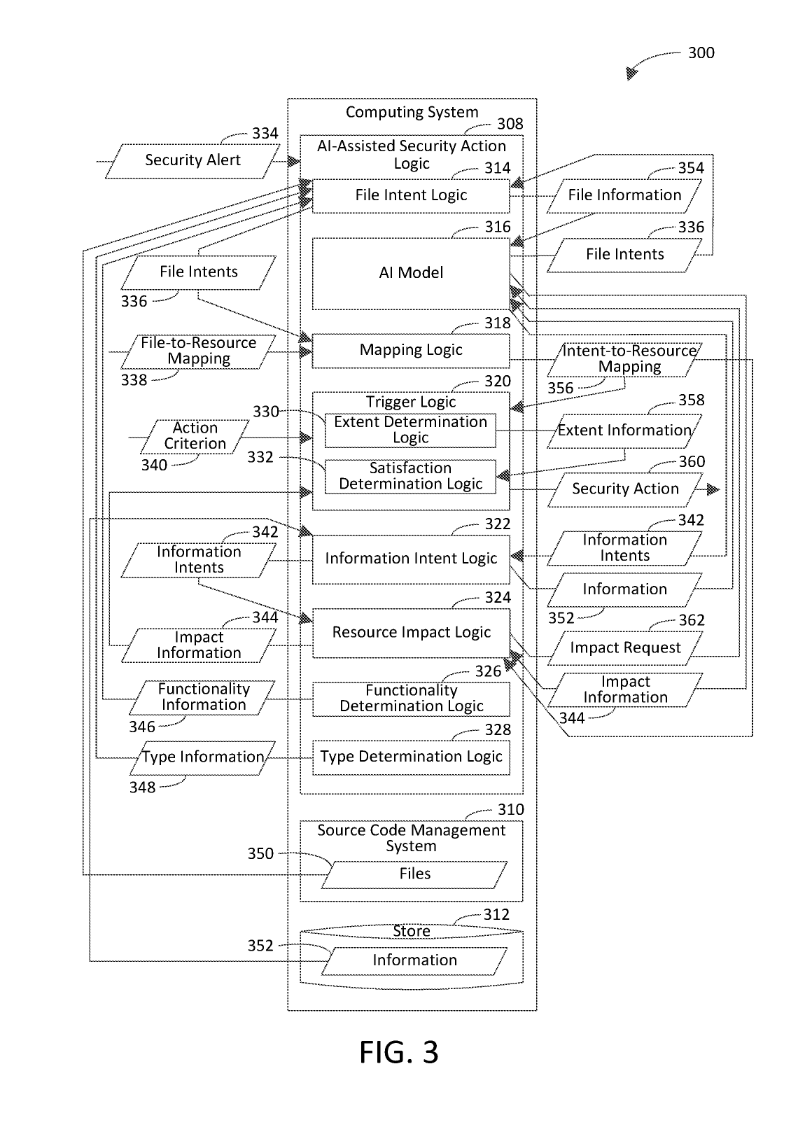

FIG. 2 depicts a flowchart 200 of an example method for performing a security action based on an AI-determined intent of a resource in an enterprise in accordance with an embodiment. Flowchart 200 may be performed by the first server(s) 106A shown in FIG. 1, for example. For illustrative purposes, flowchart 200 is described with respect to a computing system 300 shown in FIG. 3, which is an example implementation of the first server(s) 106A. As shown in FIG. 3, the computing system 300 includes AI-assisted security action logic 308, source code management (SCM) system 310, and a store 312. The AI-assisted security action logic 308 includes file intent logic 314, an AI model 316, mapping logic 318, trigger logic 320, information intent logic 322, resource impact logic 324, and functionality determination logic 326. The trigger logic 320 includes extent determination logic 330 and satisfaction determination logic 332. The SCM system 310 is shown to store files 350 for non-limiting, illustrative purposes. For instance, the files 350 may be stored in a code repository of the SCM system 310. The store 312 may be any suitable type of store. One type of store is a database. For instance, the store 312 may be a relational database, an entity-relationship database, an object database, an object relational database, an extensible markup language (XML) database, etc. The store 312 is shown to store information 352 for non-limiting, illustrative purposes. Further structural and operational embodiments will be apparent to persons skilled in the relevant art(s) based on the discussion regarding flowchart 200.

As shown in FIG. 2, the method of flowchart 200 begins at step 202. In step 202, a security alert regarding an identified resource in an information technology infrastructure of an enterprise is received. In an aspect, the security alert indicates that a potentially anomalous event has occurred with regard to the identified resource. In an example implementation, the trigger logic 320 receives a security alert 334 regarding the identified resource in the information technology infrastructure of the enterprise.

At step 204, intents of subsets of files in a source code management system regarding a software application that is utilized by the enterprise are determined using an AI model by causing the AI model to analyze contents of the files. An intent of a subset of files is a purpose or a functionality of the subset of files. Accordingly, the intents of the subsets of the files in the source code management system regarding the software application are purposes and/or functionalities of the subsets of the files regarding (e.g., in context of) the software application. Examples of an intent of a subset of files include but are not limited to a service (e.g., antivirus protection or human resources) with which the subset of files is associated that the software application provides and a user scenario (e.g., collaboration or scheduling a meeting) of the software application with which the subset of files is associated.

Example types of a file included but are not limited to code-related files and product-related files. A code-related file is a file that relates to code of the software application. In an aspect, the code of the software application is included in the software application and/or defines the software application. Examples of a code-related file include but are not limited to a code file, a “read me” file, a pipeline file, a project description, a YAML file, an extensible markup language (XML) file, a network management system (NetXMS) file, and an information technology (IT) support ticket. For instance, the IT support ticket may be generated by a tool or platform, such as an Azure DevOps® (ADO) development tool suite, developed and distributed by Microsoft Corporation; a GitHub® platform, developed and distributed by GitHub, Inc., which is now a subsidiary of Microsoft Corporation; and Slack®, developed and distributed by Slack Technologies, Inc., which is now a subsidiary of Salesforce, Inc. A code file is a file that includes code (e.g., code of the software application). A product-related file is a file that relates to use of the software application. Examples of a product-related file include but are not limited to a board (e.g., an issue board), a feature request, a prioritization of features, a list of users, communication(s) of user(s) of the software application (e.g., an instant message or an email), and a Wiki page.

A source code management system (a.k.a. a “version control system”) is a system that tracks changes to code file(s) over time. For instance, the source code management system may help a developer collaborate on code, maintain a history of changes to the code file(s), and manage multiple versions of a codebase that includes the code file(s). Examples of a source code management system include but are not limited to the GitHub® platform; a GitLab® platform, developed and distributed by GitLab Inc.; a Bitbucket® platform, developed and distributed by Atlassian Corporation Plc; a Perforce Helix Core® platform, developed and distributed by Perforce Software, Inc.; a Subsersion® (SVN) platform, developed and distributed by CollabNet, Inc.; and a Mercurial platform, developed and distributed by Matt Mackall et al.

In an aspect, the software application is a line-of-business (LoB) application. A LoB application is an application that is configured to support and automate core function(s) and process(es) of a particular business or industry. Examples of a core function include but are not limited to customer relationship management (CRM), enterprise resource planning (ERP), human resources (HR) management, inventory management, accounting and financial management, project management, supply chain management, healthcare management, and retail point-of-sale (POS). CRM includes management of customer interactions, sales processes, and customer service. ERP includes integration of multiple business processes (e.g., finance, HR, supply chain, and manufacturing). HR management includes management of employee records, payroll recruitment, and employee performance. Inventory management includes tracking inventory levels, orders, sales, and deliveries. Accounting and financial management includes management of financial transactions, budgeting, and financial reporting. Project management includes planning, executing, and monitoring projects to facilitate completion of the projects within a defined period of time and within a defined budget. Supply chain management includes overseeing a flow of goods and services from suppliers to customers. Healthcare management includes management of patient records, appointments, billing, and compliance in a healthcare environment. Retail POS includes processing sales transactions, managing inventory, and handling customer loyalty programs.

In an aspect, determining the intents of the subsets of the files in the source code management system at step 204 decreases an amount of time and/or resources (e.g., processor cycles, memory, network bandwidth) that is consumed to determine a security action that is to be performed in response to the security alert. In another aspect, determining the intents at step 204 increases efficiency of a computing system (e.g., computing system 300) that is used to determine the security action that is to be performed. In yet another aspect, determining the intents at step 204 increases security of the information technology infrastructure of the enterprise, one or more resources in the information technology infrastructure, and/or the software application that is utilized by the enterprise. In still another aspect, determining the intents at step 204 increases a user experience and/or an efficiency of a security professional who manages security of the information technology infrastructure of the enterprise.

In an example implementation, the file intent logic 314 determines file intents 336 regarding the software application that is utilized by the enterprise using the AI model 316 by causing the AI model 316 to analyze contents of the files 350. The file intents 336 are intents of subsets of the files 350 in the SCM system 310. In an aspect, the file intent logic 314 retrieves the files form the SCM system 310. In accordance with this aspect, the file intent logic 314 generates file information 354, which indicates (e.g., describes) the files 350. By providing an AI prompt that requests the file intents 336 together with contextual information, which includes the file information 354, as inputs to the AI model 316, the file intent logic 314 may cause the AI model 316 to generate the file intents 336. The contextual information includes context regarding the AI prompt. In another aspect, the software application (e.g., code that defines the software application) is stored in the SCM system 310 (e.g., a code repository of the SCM 310). A code repository is a store (e.g., storage) in which code (e.g., code of the software application) and files that are related to the code are stored.

In an example graph RAG embodiment, the intents of the subsets of the files are determined at step 204 using a graph retrieval-augmented generation (RAG) technique. A graph RAG technique is a technique that combines knowledge graph(s) with large language model(s) to increase relevance (e.g., accuracy, precision, and/or reliability) of response(s) generated by the large language model(s). A knowledge graph is a structured representation of information that includes nodes and edges. The nodes represent entities (e.g., people, places, or concepts). The edges represent relationships between subsets (e.g., pairs) of the nodes. In accordance with the graph RAG embodiment, the nodes represent the subsets of the files in the source code management system, and the edges represent relationships between the subsets of the files. In an aspect, the graph retrieval-augmented generation technique takes into consideration hierarchical relationships among the subsets of the files.

At step 206, the intents are mapped to subsets of resources in the information technology infrastructure based at least on a mapping of the subsets of the files to the subsets of the resources. Example types of a resource include but are not limited to hardware resources, software resources, and network resources. Examples of a hardware resource include but are not limited to a server, a storage device (e.g., solid-state drive (SSD) or a network-attached storage (NAS)), network equipment (e.g., a router, a switch, or a firewall), and a data center. Examples of a software resource include but are not limited to an operating system, an enterprise application, a database management system (DBMS), a software subscription, a virtual machine, an identity (e.g., an identity of a user of a resource, a software application, or an enterprise), a secret, a process, a file, and a folder. Examples of a network resource include but are not limited to a local area network (LAN), a wide area network (WAN), and an Internet connectivity component (e.g., an Internet service provider (ISP) component or a virtual private network (VPN) component). For instance, an ISP component may provide Internet access, email, web hosting, and domain registration. A VPN component may provide encryption, privacy, remote access, and bypassing of geo-restrictions.

Any one or more (e.g., all) of the resources may be a runtime resource. A runtime resource is a resource that is required for a software application to execute. In an aspect, the runtime resource(s) are provided by a runtime environment or a runtime system, which serves as an intermediary between code of the software application and the underlying hardware and operating system associated with the software application. A runtime resource may have any suitable functionality, including but not limited to memory management, input/output management, error handling, debugging, and optimization. Memory management includes allocating and deallocating memory as needed by the software application. Input/output management includes handling data input from input devices (e.g., a keyboard, a keypad, or a microphone) and output to output devices (e.g., a screen, a speaker, or a printer). Error handling includes management of exceptions and errors that occur during execution of the software application. Debugging includes providing tool(s) that enable a user (e.g., a developer) of the software application to find and fix bugs in the software application. Optimization includes increasing performance of the software application (e.g., by optimizing execution of the software application).

In an aspect, mapping the intents to the subsets of the resources in the information technology infrastructure at step 206 decreases an amount of time and/or resources (e.g., processor cycles, memory, network bandwidth) that is consumed to determine a security action that is to be performed in response to the security alert. In another aspect, mapping the intents to the subsets of the resources at step 206 increases efficiency of a computing system (e.g., computing system 300) that is used to determine the security action that is to be performed. In yet another aspect, mapping the intents to the subsets of the resources at step 206 increases security of the information technology infrastructure of the enterprise, one or more resources in the information technology infrastructure, and/or the software application that is utilized by the enterprise. In still another aspect, mapping the intents to the subsets of the resources at step 206 increases a user experience and/or an efficiency of a security professional who manages security of the information technology infrastructure of the enterprise.

In an example implementation, the mapping logic 318 maps the file intents 336 to respective subsets of the resources in the information technology infrastructure based at least on a file-to-resource mapping 338 of the subsets of the files 350 to the subsets of the resources. The mapping logic 318 generates intent-to-resource mapping 356, which indicates that the file intents 336 are mapped to the respective subsets of the resources. In an aspect, the intent-to-resource mapping 356 includes a mapping of the file intents 336 to the respective subsets of the resources. In another aspect, the intent-to-resource mapping 356 cross-references the file intents 336 to the respective subsets of the resources.

In an example security graph embodiment, the information technology infrastructure of the enterprise is represented by a security graph. The security graph includes hierarchical resource nodes and edges. The hierarchical resource nodes represent the resources in the information technology infrastructure. The edges in the security graph represent relationships between subsets (e.g., pairs) of the hierarchical resource nodes. The hierarchical resource nodes are distributed among a plurality of hierarchical levels of a resource node hierarchy. A resource represented by a hierarchical resource node in a relatively higher hierarchical level of the resource node hierarchy includes each resource represented by a hierarchical resource node in a relatively lower hierarchical level of the resource node hierarchy that is connected to the hierarchical resource node in the relatively higher hierarchical level.

In an aspect of the security graph embodiment, a file graph includes hierarchical file nodes and edges. The hierarchical file nodes represent subsets of the files 350 in the source code management system 310. The edges in the file graph represent relationships between subsets of the hierarchical file nodes. The hierarchical file nodes are distributed among a plurality of hierarchical levels of a file node hierarchy. A file represented by a hierarchical file node in a relatively higher hierarchical level of the file node hierarchy includes each file represented by a hierarchical file node in a relatively lower hierarchical level of the file node hierarchy that is connected to the hierarchical file node in the relatively higher hierarchical level.

In another aspect of the security graph embodiment, the file-to-resource mapping 338 is generated between subsets of the hierarchical file nodes in the file graph and subsets of hierarchical resource nodes in the security graph using the AI model 316. The file-to-resource mapping 338 is generated by providing file attribute information and resource attribute information as inputs to the AI model 316. The file attribute information describes the attributes of the files 350. The resource attribute information describes attributes of the resources in the information technology infrastructure. Providing the file attribute information and the resource attribute information as the inputs to the AI model 316 causes the AI model 316 to determine relationships between the attributes of the files 350 and the attributes of the resources. In an example implementation, the mapping logic 318 generates the file-to-resource mapping 338 between subsets of the hierarchical file nodes in the file graph and subsets of hierarchical resource nodes in the security graph using the AI model 316.

In another example embodiment, mapping the intents to the subsets of the resources at step 206 includes merging a first intent of a first subset of the files and a second intent of a second subset of the files to provide a combined intent of a combined subset of the files. In an example implementation, the mapping logic 318 generates the combined intent of the combined subset of the files 350 by merging the first intent of the first subset of the files 350 and the second intent of the second subset of the files 350. In accordance with this embodiment, mapping the intents to the subsets of the resources at step 206 further includes mapping the combined intent of the combined subset of the files to an identified subset of the resources, which is included in the subsets of the resources. For instance, the identified subset of the resources may include the identified resource. In an example implementation, the mapping logic 318 maps the combined intent of the combined subset of the files 350 to the identified subset of the resources.

At step 208, in response to the security alert, execution of an instruction (e.g., a computer-readable instruction) is triggered (e.g., automatically triggered) as a result of an identified intent that is mapped to the identified resource satisfying an action criterion associated with a designated security action. Triggering the execution of the instruction causes the designated security action to be performed with regard to the identified resource. The designated security action is performed by selecting the designated security action from a plurality of security actions. The identified intent is a purpose or a functionality associated with (e.g., provided by or implemented by) the identified resource. Examples of the identified intent include but are not limited to a service (e.g., antivirus protection or human resources) and a user scenario (e.g., collaboration or scheduling a meeting) that the identified resource is configured to provide.

Each security action in the plurality of security actions (including the designated security action) is an action that is configured to increase security of the enterprise. In an aspect, each security action in the plurality of security actions is configured to increase security of the identified resource, a computing system that utilizes the identified resource, and/or the software application that is utilized by the enterprise. Examples of a security action include but are not limited to turning off a virtual machine; blocking a virtual machine from accessing the Internet; rotating, executing, deleting, or encrypting a secret; blocking a user of the enterprise (e.g., an end user of the software application and/or the identified resource) from accessing the information technology infrastructure of the enterprise or resource(s) therein; changing permissions (e.g., read write, execute, full control) with regard to a user and/or resource(s) (e.g., the identified resource); and providing a notice (e.g., an alert) to a user (e.g., a security professional or an end user) regarding the security alert. In an aspect, the identified intent satisfies the action criterion as a result of a value of an attribute of the identified intent reaching (e.g., exceeding or being less than) a threshold value.

An action criterion is a criterion that, when satisfied, triggers performance of a security action. For example, a first security action may be performed in response to satisfaction of a first action criterion; a second security action may be performed in response to satisfaction of a second action criterion, and so on. In accordance with this example, the first criterion and the second criterion may be mutually exclusive, though the example embodiments are not limited in this respect.

In an aspect, the action criterion establishes a threshold (e.g., maximum) extent that a security action is allowed to negatively affect the enterprise. In accordance with this aspect, the identified intent indicates an extent to which the designated security action is capable of negatively affecting the enterprise. In further accordance with this aspect, the designated security action is selected from the plurality of security actions at step 208 as a result of the extent to which the designated security action is capable of negatively affecting the enterprise, as indicated by the identified intent, being less than or equal to the threshold extent established by the action criterion.

In another aspect, the action criterion requires that potential benefits of the designated security action outweigh negative consequences of the designated security action to an extent that is greater than the extent to which potential benefits of each of the other security actions in the plurality of security actions outweigh negative consequences of the respective security action. In accordance with this aspect, the identified intent indicates the potential benefits and the negative consequences of each security action in the plurality of security actions. In further accordance with this aspect, the designated security action is selected from the plurality of security actions at step 208 as a result of the identified intent indicating that the potential benefits of the designated security action outweighing the negative consequences of the designated security action to an extent that is greater than the extent to which the potential benefits of each of the other security actions in the plurality of security actions outweigh the negative consequences of the respective security action.

In yet another aspect, the action criterion requires that a magnitude (e.g., severity) of negative consequences of the designated security action are less than a magnitude of negative consequences of each of the other security actions in the plurality of security actions. In accordance with this aspect, the identified intent indicates the magnitude of the negative consequences of each security action in the plurality of security actions. In further accordance with this aspect, the designated security action is selected from the plurality of security actions at step 208 as a result of the identified intent indicating that the magnitude of the negative consequences of the designated security action is less than the magnitude of the negative consequences of each of the other security actions in the plurality of security actions.

In still other aspects, the identified intent satisfying the action criterion may include the identified resource being subject to (or not subject to) a regulation or a law, the attribute complying with (or not complying with) a regulation or a law, a dependency of the identified resource satisfying the action criterion, a determination that performing the designated security action will comply with a regulation or a law, a determination that performing the designated security action will cause a negative impact on the software application to an extent that is less than an extent threshold, a determination that performing the designated security action has a likelihood of causing a negative impact on the software application that is less than a likelihood threshold, a determination that not performing the designated security action will negatively impact the software application to an extent that is greater than an extent threshold, a determination that not performing the designated security action has a likelihood of negatively impacting the software application that is greater than a likelihood threshold, and so on.

In an example implementation, in response to the security alert 334, the triggering logic 320 triggers the execution of the instruction, which causes a security action 360 to be performed with regard to the identified resource by selecting the security action 360 from the plurality of security actions. In accordance with this implementation, the triggering logic 320 triggers the execution of the instruction as a result of the identified intent that is mapped to the identified resource satisfying an action criterion 340 associated with the security action 360. For example, the triggering logic 320 may analyze the intent-to-resource mapping 356 to determine that the identified intent is mapped to the identified resource. In accordance with this example, the triggering logic 320 may determine that the identified intent satisfies the action criterion 340 by comparing the identified intent to the action criterion 340.

In an example embodiment, determining the intents of the subsets of the files at step 204 includes determining a first intent of a first subset of the files by combining a plurality of sub-intents of a plurality of files in the first subset that are associated with respective sub-components of the software application. In accordance with this embodiment, mapping the intents to the subsets of the resources at step 206 includes mapping the first intent to a first subset of the resources in the information technology infrastructure based at least on the mapping of the subsets of the files to the subsets of the resources including a mapping of the first subset of the files to the first subset of the resources.

In some example embodiments, the file intent logic 314 provides an AI prompt together with contextual information as inputs to the AI model 316, which causes the AI model 316 to determine the file intents 336. The AI prompt requests determination of the file intents 336. The contextual information includes context regarding the AI prompt. The contextual information includes the file information 354. In an aspect, the AI model 316 generates the file intents 336 by analyzing the AI prompt and the contextual information. In accordance with this aspect, by analyzing the contextual information, the AI model 316 determines relationships between attributes of the files 350 in the source code management system 310 that are indicated by the file information 354 and potential intents thereof.

In an example embodiment, the file intent logic 314 causes (e.g., triggers) the AI model 316 to analyze (e.g., develop and/or refine an understanding of) the AI prompt, the contextual information (including the file information 354 and potential intents of the files 350), relationships between any of the foregoing, and confidences in those relationships. For example, the file intent logic 314 may cause the AI model 316 to compare attributes of the AI prompt and the contextual information (including the file information 354 and the potential intents of the files 350) using artificial intelligence to determine the file intents 336. The contextual information may further include sample AI prompt(s), sample file information (e.g., sample file attribute information), and sample potential intents.

In some example embodiments, the AI model 316 includes a neural network that uses the artificial intelligence to determine (e.g., predict) relationships between the AI prompt and the contextual information (including the file information 354 and potential intents of the files 350) and confidences in the relationships. The neural network uses those relationships to determine the file intents 336. For example, attributes of the AI prompt, the contextual information, and potentially example AI prompt(s), and example file information may be compared to determine similarities and differences between those attributes. In accordance with this example, the neural network may use those similarities and differences to determine the file intents 336.

Examples of a neural network include but are not limited to a feed forward neural network and a transformer-based neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the file intent logic 314 employs a feed forward neural network to train the AI model 316, which is used to determine AI-based confidences. Such AI-based confidences may be used to determine likelihoods that events will occur.

A transformer-based neural network is a neural network that incorporates a transformer. A transformer is a deep learning model that utilizes attention to differentially weight the significance of each portion of sequential input data, such as natural language. Attention is a technique that mimics cognitive attention. Cognitive attention is a behavioral and cognitive process of selectively concentrating on a discrete aspect of information while ignoring other perceivable aspects of the information. Accordingly, the transformer uses the attention to enhance some portions of the input data while diminishing other portions. The transformer determines which portions of the input data to enhance and which portions of the input data to diminish based on the context of each portion. For instance, the transformer may be trained to identify the context of each portion using any suitable technique, such as gradient descent.

In an example embodiment, the transformer-based neural network generates a file intent model (e.g., to determine intents of files in a source code management system) by utilizing information, such as AI prompts, contextual information (including the file information 354 and potential intents of the files 350), relationships between any of the foregoing, and AI-based confidences that are derived therefrom.

In example embodiments, the file intent logic 314 includes training logic, and the AI model 316 includes inference logic. The training logic is configured to train an AI algorithm that the inference logic uses to determine (e.g., infer) the AI-based confidences. For instance, the training logic may provide sample AI prompts and sample contextual information (e.g., including sample file information and sample potential intents of sample files) as inputs to the AI algorithm to train the AI algorithm. The sample data may be labeled. The AI algorithm may be configured to derive relationships between the features (e.g., the AI prompt and the contextual information, including the file information 354 and potential intents of the files 350) and the resulting AI-based confidences. The inference logic is configured to utilize the AI algorithm, which is trained by the training logic, to determine the AI-based confidence when the features are provided as inputs to the algorithm.

In an example embodiment, the AI model 316 includes (e.g., is) a generative language model. A generative language model is an AI model that is capable of generating original text output based on sample data. Examples of a generative language model include but are not limited to a generative pre-trained transformer 3 (a.k.a., GPT-3®) model and a generative pre-trained transformer 4 (a.k.a. GPT-4®) model, developed and distributed by OpenAI, Inc.; a large language model Meta AI (a.k.a. LLaMA®) model, developed and distributed by Meta Platforms Inc.; a language model for dialogue applications (a.k.a., LaMDA®) model and a Gemini® model, developed and distributed by Google LLC; and a BigScience large open-science open-access multilingual language model (a.k.a. BLOOM) model, developed and distributed by the BigScience collaborative initiative. A generative language model may use any suitable relevancy determination and/or ranking technique. For instance, the generative language model may use a BM25 (a.k.a. Okapi BM25) ranking function to perform its analysis (e.g., based on keywords).

In another example embodiment, the AI model 316 includes a large language model (LLM). A large language model is an artificial neural network that is capable of performing natural language processing (NLP) tasks. For instance, the large language model may use a transformer model to perform the NLP tasks. In an aspect, the large language model is trained (e.g., pre-trained) using self-supervised learning and semi-supervised learning. Examples of a large language model include but are not limited to the GPT-3® and GPT-4® models, developed and distributed by OpenAI, Inc.; the LLaMA® model, developed and distributed by Meta Platforms Inc.; and a pathways language model (a.k.a., PaLM®) model and the Gemini® model, developed and distributed by Google LLC.

In yet another example embodiment, the AI model 316 includes an embedding model. An embedding model is an AI model that uses deep learning to convert data into vectors, which represent attributes of the data, and that compares at least a subset of the vectors to determine an extent to which the vectors that are included in the subset are similar. For instance, each vector may represent a semantic meaning of one or more of the files 350.

In still another example embodiment, the AI model 316 includes multiple types of AI models. Weights may be applied to the responses generated by the respective types of AI models. For example, the AI model 316 may include a generative AI model and an embedding model. In accordance with this example, a first weight may be applied to a first response generated by the generative AI model to provide a first weighted response, and a second weight that is different from the first weight may be applied to a second response of the embedding model to provide a second weighted response. The AI model 316 may combine (e.g., sum) the first weighted response and the second weighted response to generate a response of the AI model 316.

In an embedding model embodiment, the AI model 316 determines the file intents 336 using an embedding model. In an aspect of this embodiment, the embedding model is an encoder-only model. One example of an encoder-only model is the bidirectional encoder representations from transformers (BERT™) model, which is developed and distributed by Google LLC. In another aspect of this embodiment, the embedding model is a decoder-only model. In yet another aspect of this embodiment, the embedding model is an encoder-decoder model. One example of an encoder-decoder model is the FLAN-T5™ model, which is developed and distributed by Google LLC.

In another example embodiment, the AI model 316 determines the relationships between the files 350 (e.g., attributes of the files 350) based on distances between embeddings (a.k.a. tokens) of the files 350. An embedding is a numerical representation of data (e.g., one or more of the files 350 or a description or summary thereof). For instance, the embedding may be generated by converting the data (e.g., text) into a vector (e.g., an array of numbers). In an aspect, the embedding represents the meaning and the context of the data. In accordance with this aspect, the distance between a first embedding and a second embedding corresponds to a strength of a relationship (e.g., similarity) between a first subset of the files 350 represented by the first embedding and a second subset of the files 350 represented by the second embedding. For instance, the distance being relatively shorter indicates that the first subset of the files 350 represented by the first embedding corresponds to the second subset of the files 350 represented by the second embedding to a relatively greater extent, whereas the distance being relatively longer indicates that the first subset of the files 350 represented by the first embedding corresponds to the second subset of the files 350 represented by the second embedding to a relatively lesser extent.

The distance between a first embedding and a second embedding may be any suitable type of distance, including but not limited to a Euclidian distance (a.k.a. Pythagorean distance), a Manhattan distance, or a Cosine distance. A Euclidian distance between two vectors is the length of the shortest line between the vectors. For example, the Euclidian distance, D_{E}, between two 2-dimensional vectors (a, b) and (x, y) may be represented as D_{E} = [(a - x)^2 + (b - y)^2]^(1/2). In another example, the Euclidian distance, D_{E}, between two 3-dimensional vectors (a, b, c) and (x, y, z) may be represented as D_{E} = [(a - x)^2 + (b - y)^2 + (c - z)^2]^(1/2). A Manhattan distance between two vectors is a sum of absolute differences between corresponding components of the vectors. For example, the Manhattan distance, D_{M}, between two 2-dimensional vectors (a, b) and (x, y) may be represented as D_{M} = Abs(a – x) + Abs(b – y). In another example, the Manhattan distance, D_{M}, between two 3-dimensional vectors (a, b, c) and (x, y, z) may be represented as D_{M} = Abs(a – x) + Abs(b – y) + Abs(c – z). A Cosine distance between two vectors is equal to a dot product of the vectors divided by a product of the magnitudes of the vectors. Accordingly, the Cosine distance, D_{C}, between vectors X and Y may be represented as D_{C} = (X · Y) / (||X|| * ||Y||).

An embedding that represents multiple files may be a combination (e.g., average or median) of respective embeddings of the files.

The AI model 316 may define the subsets of the files 350 and the subsets of the resources to generate the file-to-resource mapping 338 using a clustering algorithm or a gradient algorithm. In an example clustering embodiment, the AI model 316 clusters the subsets of the files 350 into respective clusters by analyzing first embeddings, which represent the files 350, using a clustering algorithm. In another example clustering embodiment, the AI model 316 clusters the subsets of resources into respective clusters by analyzing second embeddings, which represent the resources, using the clustering algorithm. The clustering algorithm may be density-based, distribution-based, centroid-based, or hierarchical-based. A density-based clustering algorithm clusters data points (e.g., the subsets of the files 350 or the subsets of resources), which are included in an area having a relatively high concentration of data points that is surrounded by area(s) having a relatively low concentration of data points, into a cluster. A distribution-based clustering algorithm clusters data points into clusters based on a distance of each data point to the center of each of multiple clusters, such that the data point is included in the cluster having a center that is closer to the data point than the center of each other cluster. A centroid-based clustering algorithm clusters data points into clusters based on a squared distance of each data point from each of multiple centroids in the data, such that the data point is included in the cluster corresponding to the centroid with the shortest squared distance to the data point. A hierarchical-based clustering algorithm clusters data points based on which of multiple hierarchical levels of a hierarchy includes the data points. For example, data points corresponding to a first hierarchical level are clustered into a first cluster; data points corresponding to a second hierarchical level are clustered into a second cluster, and so on.

In an aspect, the subsets of the files 350 are clustered into respective clusters as a result of the subsets of the files 350 corresponding to respective attributes. For example, a first subset of the files 350 may be clustered into a first cluster as a result of the first subset of the files 350 sharing a first attribute. A second subset of the files 350 may be clustered into a second cluster as a result of the second subset of the files 350 sharing a second attribute, and so on. In another example, a designated (e.g., fixed) number of the files 350 (e.g., 1, 2, 3, or 10) may be selected from each cluster to be included in the file-to-resource mapping 338.

In another aspect, the subsets of the resources are clustered into respective clusters as a result of the subsets of the resources corresponding to respective attributes. For example, a first subset of the resources may be clustered into a first cluster as a result of the first subset of the resources sharing a first attribute. A second subset of the resources may be clustered into a second cluster as a result of the second subset of the resources sharing a second attribute, and so on. In another example, a designated (e.g., fixed) number of the resources (e.g., 1, 2, 3, or 10) may be selected from each cluster to be included in the file-to-resource mapping 338.

In an aspect of the clustering embodiment, the clustering algorithm is a K-means clustering algorithm. The K-means clustering algorithm is an unsupervised learning centroid-based clustering algorithm. In an aspect, the K-means clustering algorithm attempts to minimize the variance of data points within each cluster.

In another aspect of the clustering embodiment, the clustering algorithm is a density-based spatial clustering of applications with noise (DBSCAN) clustering algorithm. As indicated by its name, the DBSCAN clustering algorithm is a density-based clustering algorithm. The DBSCAN clustering algorithm defines arbitrarily shaped clusters based on density of data points in regions that are separated by areas of low-density.

Other examples of a clustering algorithm include but are not limited to a Gaussian mixture clustering algorithm, a balance iterative reducing and clustering using hierarchies (BIRCH) clustering algorithm, an affinity propagation clustering algorithm, a mean-shifting clustering algorithm, an ordering points to identify the clustering structure (OPTICS) clustering algorithm, and an agglomerative hierarchy clustering algorithm.

In some example embodiments, one or more steps 202, 204, 206, and/or 208 of flowchart 200 may not be performed. Moreover, steps in addition to or in lieu of steps 202, 204, 206, and/or 208 may be performed. For instance, in an example embodiment, the method of flowchart 200 further includes identifying a first subset of the files by scanning a container image that is stored in the source code management system. In an example implementation, the file intent logic 314 identifies a first subset of the files 350 by scanning a container image that is stored in the source code management system 310. For instance the container image may be a Kubernetes® pod. A Kubernetes® pod represents one or more containers that share storage, network resources, and a specification that indicates how the one or more containers are to be run. In an aspect, the Kubernetes® pod is configured to host a single instance of a running process (e.g., in a cluster). In another aspect, the Kubernetes® pod is the smallest unit in a Kubernetes® ecosystem.

In another example embodiment, the method of flowchart 200 further includes determining second intents of subsets of information regarding the software application using the AI model by causing the AI model to analyze the information. The subsets of the information include subset(s) of documentation regarding the software application and/or subset(s) of communications regarding the software application. In an example implementation, the information intent logic 322 determines information intents 342 of subsets of information 352 regarding the software application using the AI model 316 by causing the AI model 316 to analyze the information 352. The subsets of the information 352 include one or more subsets of documentation regarding the software application and/or one or more subsets of communications regarding the software application. In accordance with this embodiment, the method of flowchart 200 further includes determining impacts (e.g., business impacts) of the subsets of the resources in the information technology infrastructure on the enterprise using the AI model. For instance, an impact may indicate an amount of revenue attributable a resource or to the software application, which utilizes the resource, a number of customers of the software application, and so on. The impacts are determined using the AI model by causing the AI model to analyze the subsets of the information. The AI model is caused to analyze the subsets of the information based at least on the intents of the subsets of the resources corresponding to the second intents of the subsets of the information. In an example implementation, the resource impact logic 324 determines the impacts of the subsets of the resources in the information technology infrastructure on the enterprise using the AI model 316. The resource impact logic 324 determines the impacts by causing the AI model 316 to analyze the subsets of the information 352 based at least on the intents of the subsets of the resources, as indicated by the intent-to-resource mapping 356, corresponding to the information intents 342. In an aspect, the resource impact logic 324 provides an impact request 362, which requests a determination of the impacts of the subsets of the resources on the enterprise, to the AI model 316, which causes the AI model 316 to generate impact information 344, which indicates (e.g., specifies or describes) the impacts. In further accordance with this embodiment, the designated security action is performed at step 208 as a result of the identified intent that is mapped to the identified resource satisfying the action criterion and further as a result of an identified impact of a subset of resources that includes the identified resource satisfying a second action criterion associated with the designated security action.

In yet another example embodiment, the method of flowchart 200 further includes distinguishing the files in the source code management system, which originate from within the enterprise, from second files in the source code management system, which originate from a source that is external to the enterprise, using a source code analysis technique. In an example implementation, the file intent logic 314 distinguishes the files 350 in the source code management system 310, which originate from within the enterprise, from second files in the source code management system 310, which originate from a source that is external to the enterprise, using the source code analysis technique. In accordance with this embodiment, the intents of the subsets of the files are determined at step 204 as a result of the files being distinguished from the second files.

In still another example embodiment, the method of flowchart 200 further includes determining a functionality of the software application in context of the enterprise. In an example implementation, the functionality determination logic 326 determines the functionality of the software application in the context of the enterprise. In accordance with this implementation, the functionality determination logic 326 generates functionality information 346 to indicate the functionality of the software application in the context of the enterprise. In accordance with this embodiment, the method of flowchart 200 further includes determining a type of the identified resource. For example, the type of the identified resource may be a hardware resource, a software resource, a network resource, a server, a storage device, an SSD, a NAS, network equipment, a router, a switch, a firewall, a data center, an operating system, an enterprise application, a DBMS, a software subscription, a virtual machine, an identity, a user identity, a resource identity, a software application identity, an enterprise identifier, a secret, a process, a file, a folder, a LAN, a WAN, an Internet connectivity component, an ISP component, or a VPN component. In an example implementation, the type determination logic 328 determines the type of the identified resource. In accordance with this implementation, the type determination logic 328 generates type information 348 to indicate the type of the identified resource.

In further accordance with this embodiment, determining the intents of the subsets of the files at step 204 includes determining the identified intent of a first subset of the files by taking into consideration the functionality of the software application and the type of the identified resource. In an example implementation, the file intent logic 314 determines the identified intent of the first subset of the files 350 by taking into consideration the functionality of the software application, as indicated by the functionality information 346, and the type of the identified resource, as indicated by the type information 348. In further accordance with this embodiment, mapping the intents to the subsets of the resources at step 206 includes mapping the identified intent to a first subset of the resources that includes the identified resource based at least on the mapping of the subsets of the files to the subsets of the resources including a mapping of the first subset of the files to the first subset of the resources. In an example implementation, the mapping logic 318 maps the identified intent to the first subset of the resources, which includes the identified resource, based at least on the file-to-resource mapping 338 including the mapping of the first subset of the files 350 to the first subset of the resources.

In still another example embodiment, the method of flowchart 200 further includes determining a plurality of extents to which the plurality of security actions are capable of negative impacting customers of the enterprise by analyzing the identified intent that is mapped to the identified resource. In an example implementation, the extent determination logic 330 determines the plurality of extents to which the plurality of security actions are capable of negative impacting the customers of the enterprise by analyzing the identified intent that is mapped to the identified resource, as indicated by the intent-to-resource mapping 356. The extent determination logic 330 generates extent information 358 to indicate the plurality of extents to which the plurality of security actions are capable of negative impacting the customers of the enterprise. In accordance with this embodiment, the method of flowchart 200 further includes determining that the identified intent satisfies the action criterion by taking into consideration the extent to which the designated security action is capable of negatively impacting the customers of the enterprise. In an example implementation, the satisfaction determination logic 332 determines that the identified intent satisfies the action criterion 340 by taking into consideration the extent to which the designated security action is capable of negatively impacting the customers of the enterprise, as indicated by the extent information 358.

It will be recognized that the computing system 300 may not include one or more of the AI-assisted security action logic 308, the source code management system 310, the store 312, the file intent logic 314, the AI model 316, the mapping logic 318, the trigger logic 320, the information intent logic 322, the resource impact logic 324, the functionality determination logic 326, the extent determination logic 330, and/or the satisfaction determination logic 332. Furthermore, the computing system 300 may include components in addition to or in lieu of the AI-assisted security action logic 308, the source code management (SCM) system 310, the store 312, the file intent logic 314, the AI model 316, the mapping logic 318, the trigger logic 320, the information intent logic 322, the resource impact logic 324, the functionality determination logic 326, the extent determination logic 330, and/or the satisfaction determination logic 332.

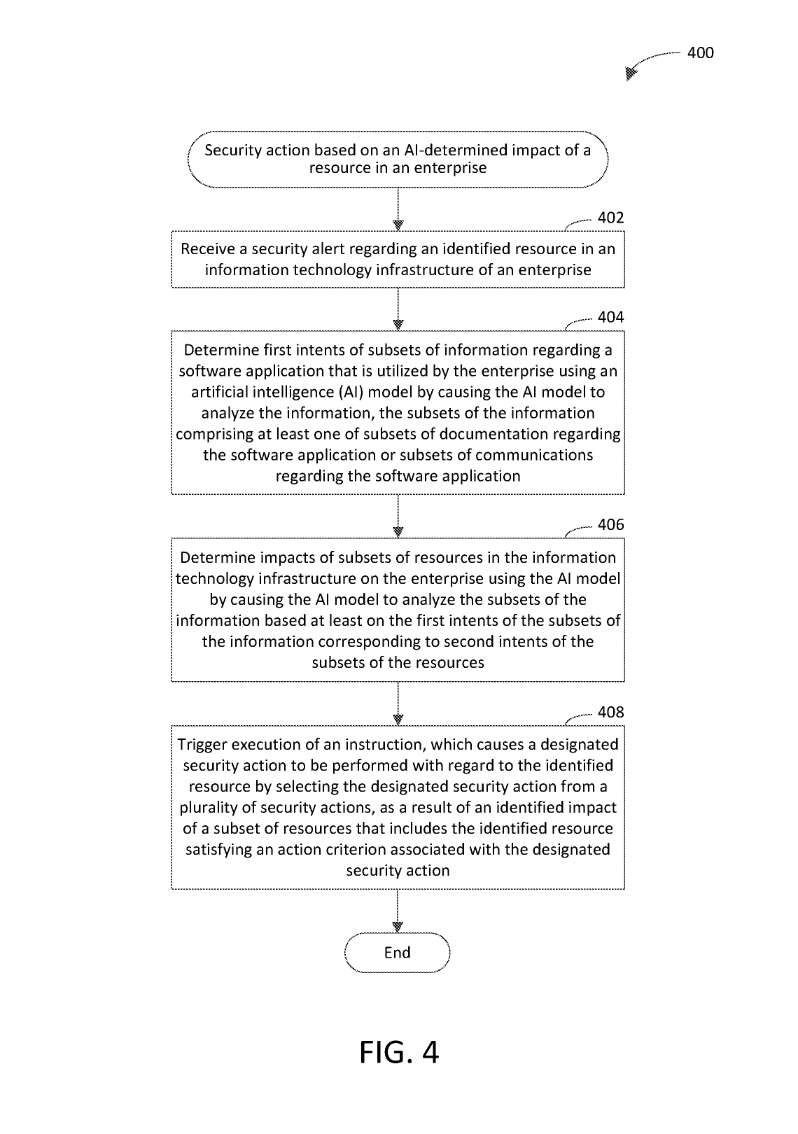

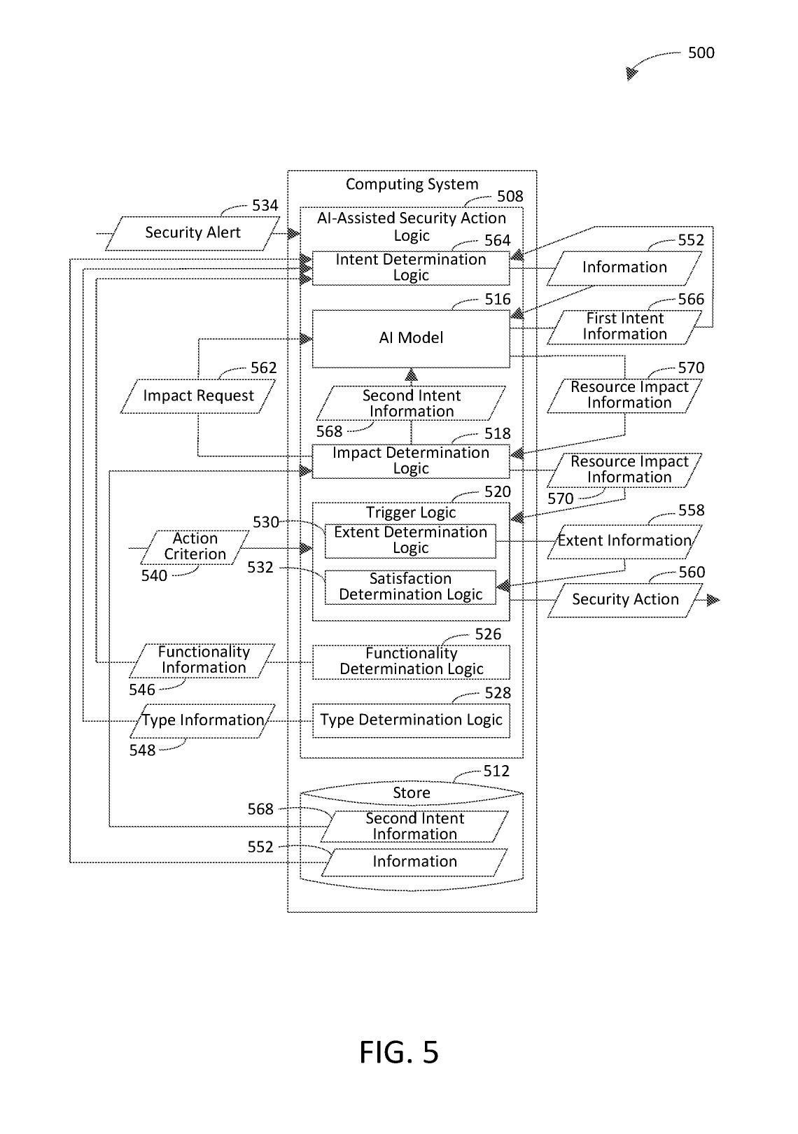

FIG. 4 depicts a flowchart 400 of an example method for performing a security action based on an AI-determined impact of a resource in an enterprise in accordance with an embodiment. Flowchart 400 may be performed by the first server(s) 106A shown in FIG. 1, for example. For illustrative purposes, flowchart 400 is described with respect to a computing system 500 shown in FIG. 5, which is an example implementation of the first server(s) 106A. As shown in FIG. 5, the computing system 500 includes AI-assisted security action logic 508 and a store 512. The AI-assisted security action logic 508 includes intent determination logic 564, an AI model 516, impact determination logic 518, trigger logic 520, functionality determination logic 526, and type determination logic 528. The trigger logic 520 includes extent determination logic 530 and satisfaction determination logic 532. The store 512 may be any suitable type of store. For instance, the store 512 may be a relational database, an entity-relationship database, an object database, an object relational database, an extensible markup language (XML) database, etc. The store 512 is shown to store second intent information 568 and information 552 for non-limiting, illustrative purposes. Further structural and operational embodiments will be apparent to persons skilled in the relevant art(s) based on the discussion regarding flowchart 400.

As shown in FIG. 4, the method of flowchart 400 begins at step 402. In step 402, a security alert regarding an identified resource in an information technology infrastructure of an enterprise is received. In an example implementation, the trigger logic 520 receives a security alert 534 regarding the identified resource in the information technology infrastructure of the enterprise.

At step 404, first intents (e.g., purposes and/or functionalities) of subsets of information regarding a software application that is utilized by the enterprise are determined using an AI model by causing the AI model to analyze the information. The subsets of the information include subset(s) of documentation regarding the software application and/or subset(s) of communications regarding the software application. In an aspect, determining the first intents of the subsets of the information regarding the software application at step 404 decreases an amount of time and/or resources (e.g., processor cycles, memory, network bandwidth) that is consumed to determine a security action that is to be performed in response to the security alert. In another aspect, determining the first intents of the subsets of the information at step 404 increases efficiency of a computing system (e.g., computing system 500) that is used to determine the security action that is to be performed. In yet another aspect, determining the first intents of the subsets of the information at step 404 increases security of the information technology infrastructure of the enterprise, one or more resources in the information technology infrastructure, and/or the software application that is utilized by the enterprise. In still another aspect, determining the first intents of the subsets of the information at step 404 increases a user experience and/or an efficiency of a security professional who manages security of the information technology infrastructure of the enterprise.

In an example implementation, the intent determination logic 564 determines first intents of respective subsets of the information 552 regarding the software application that is utilized by the enterprise using the AI model 516 by causing the AI model 516 to analyze the information 552. The subsets of the information 552 include the subset(s) of the documentation regarding the software application and/or the subset(s) of the communications regarding the software application. In an aspect, the intent determination logic 564 provides an AI prompt, which requests a determination of the intents of the subsets of the information 552, together with contextual information, which includes the information 552, as inputs to the AI model 516. The contextual information includes context regarding the AI prompt. By providing the AI prompt together with the contextual information, the intent determination logic 564 may cause the AI model 516 to determine the first intents of the respective subsets of the information 552. The AI model 516 generates first intent information 566 to indicate the first intents of the respective subsets of the information 552.

In an example embodiment, the first intents of the subsets of the information are determined at step 404 using a graph retrieval-augmented generation technique. In accordance with this embodiment, a knowledge graph includes nodes, which represent the subsets of the information regarding the software application, and the edges represent relationships between the subsets of the information. In an aspect, the graph retrieval-augmented generation technique takes into consideration hierarchical relationships among the subsets of the information.

At step 406, impacts (e.g., business impacts) of subsets of resources in the information technology infrastructure on the enterprise are determined using the AI model by causing the AI model to analyze the subsets of the information based at least on the first intents of the subsets of the information corresponding to second intents of the subsets of the resources. In an aspect, determining the impacts of the subsets of the resources in the information technology infrastructure on the enterprise using the AI model at step 406 decreases an amount of time and/or resources (e.g., processor cycles, memory, network bandwidth) that is consumed to determine a security action that is to be performed in response to the security alert. In another aspect, determining the impacts of the subsets of the resources on the enterprise using the AI model at step 406 increases efficiency of a computing system (e.g., computing system 500) that is used to determine the security action that is to be performed. In yet another aspect, determining the impacts of the subsets of the resources on the enterprise using the AI model at step 406 increases security of the information technology infrastructure of the enterprise, one or more resources in the information technology infrastructure, and/or the software application that is utilized by the enterprise. In still another aspect, determining the impacts of the subsets of the resources on the enterprise using the AI model at step 406 increases a user experience and/or an efficiency of a security professional who manages security of the information technology infrastructure of the enterprise.

In an example implementation, the impact determination logic 518 determines the impacts of the respective subsets of resources in the information technology infrastructure on the enterprise using the AI model 516 by causing the AI model 516 to analyze the subsets of the information 552 based at least on the first intents of the respective subsets of the information 552 corresponding to respective second intents of the respective subsets of the resources. In an aspect, the impact determination logic 518 provides an impact request 562 (e.g., an AI prompt) together with the second intent information 568, which indicates the second intents of the respective subsets of the resources, to the AI model 516. The first intent information 566 and the second intent information 568 include context regarding the impact request 562. Providing the impact request 562 together with the second intent information 568 to the AI model 516 may cause the AI model 516 to correlate the first intents of the respective subsets of the information 552, as indicated by the first intent information 566, with the respective second intents of the respective subsets of the resources, as indicated by the second intent information 568, and may cause the AI model 516 to determine the impacts of the respective subsets of resources on the enterprise based at least on the correlation. The AI model 516 generates resource impact information 570 to indicate the impacts of the respective subsets of the resources on the enterprise.

In an example embodiment, the information regarding the software application includes an electronic mail message regarding the software application. In accordance with this embodiment, determining the impacts of the subsets of the resources at step 406 includes deriving the identified impact of the subset of the resources that includes the identified resource from content of the electronic mail message.

In another example embodiment, the information regarding the software application includes a specification that describes features of the software application. In accordance with this embodiment, determining the impacts of the subsets of the resources at step 406 includes deriving the identified impact of the subset of the resources that includes the identified resource from content of the specification that describes the features of the software application.

In yet another example embodiment, the information regarding the software application indicates attributes of users of the software application. In accordance with this embodiment, determining the impacts of the subsets of the resources at step 406 includes deriving the identified impact of the subset of the resources that includes the identified resource from the attributes of the users of the software application.

In still another example embodiment, the identified impact of the subset of the resources that includes the identified resource includes an estimate of a number of users of the software application.

At step 408, in response to the security alert, execution of an instruction (e.g., a computer-readable instruction) is triggered (e.g., automatically triggered) as a result of an identified impact of a subset of resources that includes the identified resource satisfying an action criterion associated with a designated security action. Triggering the execution of the instruction causes the designated security action to be performed with regard to the identified resource by selecting the designated security action from a plurality of security actions. Examples of a security action include but are not limited to turning off a virtual machine; blocking a virtual machine from accessing the Internet; rotating, executing, deleting, or encrypting a secret; blocking a user of the enterprise (e.g., an end user of the software application and/or the identified resource) from accessing the information technology infrastructure of the enterprise or resource(s) therein; changing permissions (e.g., read write, execute, full control) with regard to a user and/or resource(s) (e.g., the identified resource); and providing a notice (e.g., an alert) to a user (e.g., a security professional or an end user) regarding the security alert. In an example implementation, in response to the security alert 534, the trigger logic 520 triggers execution of the instruction as a result of the identified impact of the subset of the resources that includes the identified resource, as indicated by the resource impact information 570, satisfying an action criterion 540 associated with a security action 560. The trigger logic 520 triggering the execution of the instruction causes the security action 560 to be performed with regard to the identified resource by selecting the security action 560 from the plurality of security actions.

In some example embodiments, the intent determination logic 564 provides an AI prompt together with contextual information as inputs to the AI model 516, which causes the AI model 516 to determine the first intents of the subsets of the information regarding the software application that is utilized by the enterprise, as reflected in the file intent information 566. The AI prompt requests determination of the first intents of the subsets of the information regarding the software application. The contextual information includes context regarding the AI prompt. The contextual information includes the information 552. In an aspect, the AI model 516 generates the file intent information 566 by analyzing the AI prompt and the contextual information. In accordance with this aspect, by analyzing the contextual information, the AI model 516 determines relationships between attributes of the subsets of the information 552 and potential intents of the subsets of the information 552.

In an example embodiment, the intent determination logic 564 causes (e.g., triggers) the AI model 516 to analyze (e.g., develop and/or refine an understanding of) the AI prompt, the contextual information (including the information 552), relationships between any of the foregoing, and confidences in those relationships. For example, the intent determination logic 564 may cause the AI model 516 to compare attributes of the AI prompt and the contextual information (including the information 552) using artificial intelligence to determine the first intents of the respective subsets of the information 552. The contextual information may further include sample AI prompt(s), sample information regarding sample software applications, and sample potential intents.

In other example embodiments, the impact determination logic 518 provides an AI prompt (e.g., in the form of the impact request 562) together with contextual information as inputs to the AI model 516, which causes the AI model 516 to determine the impacts of the subsets of the resources in the information technology infrastructure on the enterprise, as reflected in the resource impact information 570. The AI prompt requests determination of the impacts of the subsets of the resources in the information technology infrastructure on the enterprise. The contextual information includes context regarding the AI prompt. The contextual information includes the information 552, the first intent information 566, and the second intent information 568. In an aspect, the AI model 516 generates the resource impact information 570 by analyzing the AI prompt and the contextual information. In accordance with this aspect, by analyzing the contextual information, the AI model 516 determines relationships between attributes of the subsets of the information 552, the first intents of the subsets of the information 552, and the second intents of the subsets of the resources.

In an example embodiment, the impact determination logic 518 causes (e.g., triggers) the AI model 516 to analyze (e.g., develop and/or refine an understanding of) the AI prompt, the contextual information (including the information 552, the first intent information 566, and the second intent information 568), relationships between any of the foregoing, and confidences in those relationships. For example, the impact determination logic 518 may cause the AI model 516 to compare attributes of the AI prompt, the contextual information (including the information 552, the first intent information 566, and the second intent information 568), using artificial intelligence to determine the impacts of the subsets of the resources on the enterprise. The contextual information may further include sample AI prompt(s), sample information regarding sample software applications, sample first intents of subsets of sample information, and sample second intents of subsets of sample resources.

In some example embodiments, the AI model 516 includes a neural network that uses the artificial intelligence to determine (e.g., predict) relationships between the AI prompt, the contextual information (including the information 552, the first intent information 566, and the second intent information 568), and confidences in the relationships. The neural network uses those relationships to determine the impacts of the subsets of the resources on the enterprise. For example, attributes of the AI prompt, the contextual information, and potentially example AI prompt(s), example information regarding example software applications, example first intents of subsets of example information, and example second intents of subsets of example resources may be compared to determine similarities and differences between those attributes. In accordance with this example, the neural network may use those similarities and differences to determine the impacts of the subsets of the resources on the enterprise.

In an example embodiment, the impact determination logic 518 employs a feed forward neural network to train the AI model 516, which is used to determine AI-based confidences. Such AI-based confidences may be used to determine likelihoods that events will occur.

In an example embodiment, the AI model 516 includes a transformer-based neural network that generates an impact model (e.g., to determine impacts of subsets of resources on an enterprise) by utilizing input information, such as AI prompts, contextual information (including the information 552, the first intent information 566, and the second intent information 568), relationships between any of the foregoing, and AI-based confidences that are derived therefrom.

In example embodiments, the impact determination logic 518 includes training logic, and the AI model 516 includes inference logic. The training logic is configured to train an AI algorithm that the inference logic uses to determine (e.g., infer) the AI-based confidences. For instance, the training logic may provide sample AI prompts and sample contextual information (e.g., including sample information regarding sample software applications, sample first intents of subsets of sample information, and sample second intents of subsets of sample resources) as inputs to the AI algorithm to train the AI algorithm. The sample data may be labeled. The AI algorithm may be configured to derive relationships between the features (e.g., the AI prompt and the contextual information, including the information 552, the first intent information 566, and the second intent information 568) and the resulting AI-based confidences. The inference logic is configured to utilize the AI algorithm, which is trained by the training logic, to determine the AI-based confidence when the features are provided as inputs to the algorithm.

In an embedding model embodiment, the AI model 516 generates the resource impact information 570 using an embedding model. The embedding model may be an encoder-only model, a decoder-only model, or an encoder-decoder model. In accordance with this embodiment, the AI model 516 determines the relationships between attributes of the subsets of the information 552, the first intents of the subsets of the information 552, and the second intents of the subsets of the resources based on distances between first embeddings (a.k.a. tokens) of the subsets of the information 552 and second embeddings of the subsets of the resources. The distance between a first embedding and a second embedding may be any suitable type of distance, including but not limited to a Euclidian distance (a.k.a. Pythagorean distance), a Manhattan distance, or a Cosine distance.

A first embedding that represents a plurality of data points in the information 552 may be a combination (e.g., average or median) of a plurality of respective embeddings of the plurality of data points in the information 552. A second embedding that represents a plurality of resources may be a combination (e.g., average or median) of a plurality of respective embeddings of the plurality of respective resources.

The AI model may define the subsets of the information 552 and the subsets of the resources using a clustering algorithm or a gradient algorithm. In an example clustering embodiment, determining the impacts of the subsets of the resources on the enterprise includes clustering data points in the information 552 into respective clusters (e.g., to define the subsets of the information 552) by analyzing first embeddings, which represent the data points in the information 552, using a clustering algorithm. In another example clustering embodiment, determining the impacts of the subsets of the resources on the enterprise includes clustering the subsets of resources into respective clusters by analyzing second embeddings, which represent the resources, using the clustering algorithm. The clustering algorithm may be density-based, distribution-based, centroid-based, or hierarchical-based.

In an aspect, the subsets of the information 552 are clustered into respective clusters as a result of the subsets of the information 552 corresponding to respective attributes. For example, a first subset of the information 552 may be clustered into a first cluster as a result of the first subset of the information 552 sharing a first attribute. A second subset of the information 552 may be clustered into a second cluster as a result of the second subset of the information 552 sharing a second attribute, and so on. In another example, each of the subsets of the information 552 may have a same (e.g., pre-defined or fixed) number of data points (e.g., 1, 2, 3, or 10).

In another aspect, the subsets of the resources are clustered into respective clusters as a result of subsets of the resources corresponding to respective attributes. For example, a first subset of the resources may be clustered into a first cluster as a result of the subset of the resources sharing a first attribute. A second subset of the resources may be clustered into a second cluster as a result of the subset of the resources sharing a second attribute, and so on. In another example, each of the subsets of the resources may have a same (e.g., pre-defined or fixed) number of resources (e.g., 1, 2, 3, or 10).

In an aspect of the clustering embodiment, the clustering algorithm is a K-means clustering algorithm, a density-based spatial clustering of applications with noise (DBSCAN) clustering algorithm, a Gaussian mixture clustering algorithm, a balance iterative reducing and clustering using hierarchies (BIRCH) clustering algorithm, an affinity propagation clustering algorithm, a mean-shifting clustering algorithm, an ordering points to identify the clustering structure (OPTICS) clustering algorithm, or an agglomerative hierarchy clustering algorithm.

In some example embodiments, one or more steps 402, 404, 406, and/or 408 of flowchart 400 may not be performed. Moreover, steps in addition to or in lieu of steps 402, 404, 406, and/or 408 may be performed. For instance, in an example embodiment, the method of flowchart 400 further includes merging an intent of a first subset of the information and an intent of a second subset of the information to provide a combined intent of a combined subset of the information. In an example implementation, the intent determination logic 564 merges an intent of a first subset of the information 552 and an intent of a second subset of the information 552 to provide a combined intent of a combined subset of the information 552. In accordance with this embodiment, the method of flowchart 400 further includes mapping the combined intent of the combined subset of the information to an identified subset of the resources, which is included in the subsets of the resources. In an example implementation, the intent determination logic 564 maps the combined intent of the combined subset of the information 552 to the identified subset of the resources.

In another example embodiment, the method of flowchart 400 further includes determining a functionality of the software application in context of the enterprise. In an example implementation, the functionality determination logic 526 determines the functionality of the software application in the context of the enterprise. The functionality determination logic 526 generates functionality information 546 to indicate the functionality of the software application in the context of the enterprise. In accordance with this embodiment, the method of flowchart 400 further includes determining a type of the identified resource. In an example implementation, the type determination logic 528 determines the type of the identified resource. In further accordance with this embodiment, determining the first intents of the subsets of the information at step 404 includes determining a first intent of a first subset of the information by taking into consideration the functionality of the software application and the type of the identified resource. In further accordance with this embodiment, determining the impacts of the subsets of the resources at step 406 includes determining the identified impact of the subset of the resources that includes the identified resource based at least on the first intent of the first subset of the information corresponding to a second intent of the subset of the resources that includes the identified resource.

In yet another example embodiment, the method of flowchart 400 further includes determining a plurality of extents to which the plurality of security actions are capable of negative impacting customers of the enterprise by analyzing the identified impact of the subset of the resources that includes the identified resource. In an example implementation, the extent determination logic 530 determines the plurality of extents to which the plurality of security actions are capable of negative impacting the customers of the enterprise by analyzing the identified impact of the subset of the resources that includes the identified resource, as indicated by the resource impact information 570. The extent determination logic 530 generates extent information 558 to indicate the plurality of extents to which the plurality of respective security actions are capable of negative impacting the customers of the enterprise. For instance, the extent information 558 may cross-reference the plurality of extents with the plurality of respective security actions. In accordance with this embodiment, the method of flowchart 400 further includes determining that the identified impact of the subset of the resources that includes the identified resource satisfies the action criterion by taking into consideration the extent to which the designated security action is capable of negatively impacting the customers of the enterprise. In an example implementation, the satisfaction determination logic 532 determines that the identified impact of the subset of the resources that includes the identified resource satisfies the action criterion 540 by taking into consideration the extent to which the designated security action is capable of negatively impacting the customers of the enterprise. In an aspect, the satisfaction determination logic 532 determines the extent to which the designated security action is capable of negatively impacting the customers of the enterprise by analyzing the extent information 558.

It will be recognized that the computing system 500 may not include one or more of the AI-assisted security action logic 508, the store 512, the AI model 516, the impact determination logic 518, the trigger logic 520, the functionality determination logic 526, the type determination logic 528, the extent determination logic 530, the satisfaction determination logic 532, and/or the intent determination logic 564. Furthermore, the computing system 500 may include components in addition to or in lieu of the AI-assisted security action logic 508, the store 512, the AI model 516, the impact determination logic 518, the trigger logic 520, the functionality determination logic 526, the type determination logic 528, the extent determination logic 530, the satisfaction determination logic 532, and/or the intent determination logic 564.

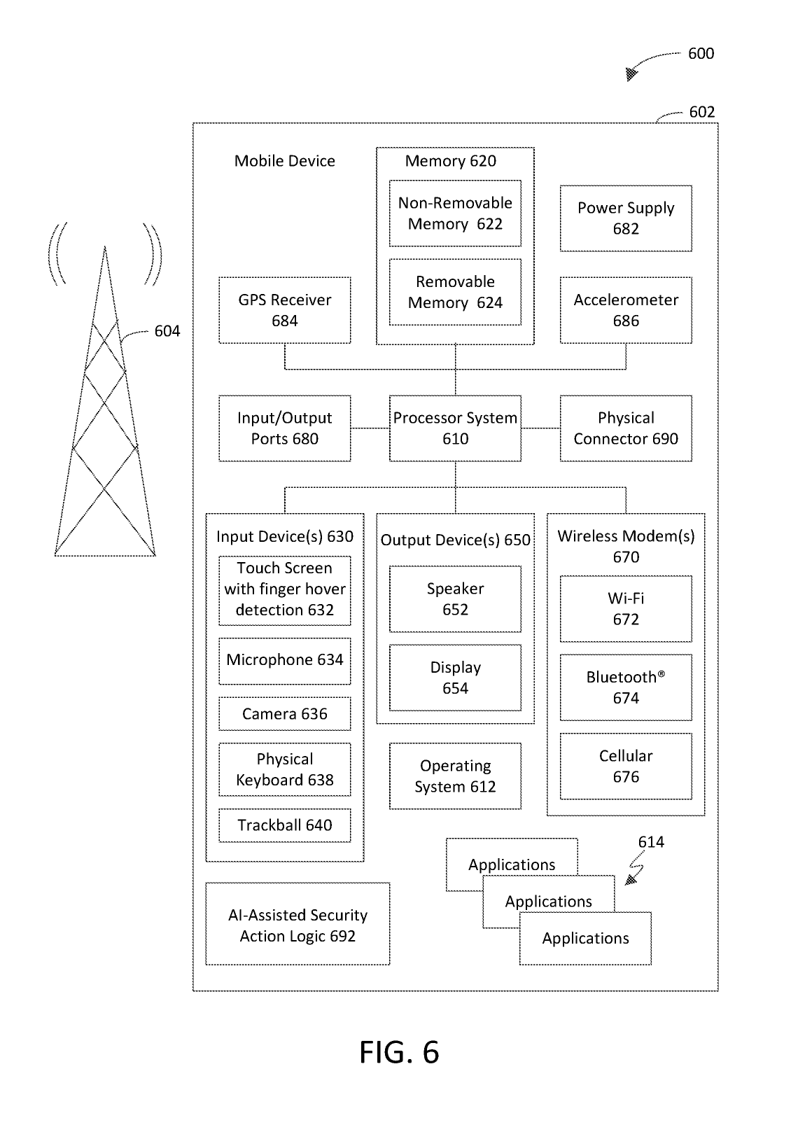

FIG. 6 is a system diagram of an example mobile device 600 including a variety of optional hardware and software components, shown generally as 602. Any components 602 in the mobile device may communicate with any other component, though not all connections are shown, for ease of illustration. The mobile device 600 may be any of a variety of computing devices (e.g., cell phone, smartphone, handheld computer, Personal Digital Assistant (PDA), etc.) and may allow wireless two-way communications with one or more mobile communications networks 604, such as a cellular or satellite network, or with a local area or wide area network.

The mobile device 600 includes a processor system 610 (e.g., signal processor, microprocessor, ASIC, or other control and processing logic circuitry) for performing such tasks as signal coding, data processing, input/output processing, power control, and/or other functions. An operating system 612 may control the allocation and usage of the components 602 and support for one or more applications 614 (a.k.a. application programs). The applications 614 may include common mobile computing applications (e.g., email applications, calendars, contact managers, web browsers, messaging applications) and any other computing applications (e.g., word processing applications, mapping applications, media player applications).

The mobile device 600 includes AI-assisted security action logic 692, which is operable in a manner similar to the AI-assisted security action logic 108 described above with reference to FIG. 1, the AI-assisted security action logic 308 described above with reference to FIG. 3, and/or the AI-assisted security action logic 508 described above with reference to FIG. 5.

The mobile device 600 includes memory 620. The memory 620 may include non-removable memory 622 and/or removable memory 624. The non-removable memory 622 may include random access memory (RAM), read-only memory (ROM), flash memory, a hard disk, or other well-known memory storage technologies. The removable memory 624 may include flash memory or a Subscriber Identity Module (SIM) card, which is well known in Global System for Mobile Communications (GSM) systems, or other well-known memory storage technologies, such as “smart cards.” The memory 620 may store data and/or code for running the operating system 612 and the applications 614. Example data may include web pages, text, images, sound files, video data, or other data sets to be sent to and/or received from one or more network servers or other devices via one or more wired or wireless networks. Memory 620 may store a subscriber identifier, such as an International Mobile Subscriber Identity (IMSI), and an equipment identifier, such as an International Mobile Equipment Identifier (IMEI). Such identifiers may be transmitted to a network server to identify users and equipment.

The mobile device 600 may support one or more input devices 630, such as a touch screen 632, microphone 634, camera 636, physical keyboard 638 and/or trackball 640 and one or more output devices 650, such as a speaker 652 and a display 654. Touch screens, such as the touch screen 632, may detect input in different ways. For example, capacitive touch screens detect touch input when an object (e.g., a fingertip) distorts or interrupts an electrical current running across the surface. As another example, touch screens may use optical sensors to detect touch input when beams from the optical sensors are interrupted. Physical contact with the surface of the screen is not necessary for input to be detected by some touch screens. For example, the touch screen 632 may support a finger hover detection using capacitive sensing, as is well understood. Other detection techniques may be used, including camera-based detection and ultrasonic-based detection. To implement a finger hover, a user’s finger is typically within a predetermined spaced distance above the touch screen, such as between 0.1 to 0.25 inches, or between 0.25 inches and 0.5 inches, or between 0.5 inches and 0.75 inches, or between 0.75 inches and 1 inch, or between 1 inch and 1.5 inches, etc.

Other possible output devices (not shown) may include piezoelectric or other haptic output devices. Some devices may serve more than one input/output function. For example, touch screen 632 and display 654 may be combined in a single input/output device. The input devices 630 may include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 612 or applications 614 may include speech-recognition software as part of a voice control interface that allows a user to operate the mobile device 600 via voice commands. Furthermore, the mobile device 600 may include input devices and software that allows for user interaction via a user’s spatial gestures, such as detecting and interpreting gestures to provide input to a gaming application.

Wireless modem(s) 670 may be coupled to antenna(s) (not shown) and may support two-way communications between the processor system 610 and external devices, as is well understood in the art. The modem(s) 670 are shown generically and may include a cellular modem 676 for communicating with the mobile communication network 604 and/or other radio-based modems (e.g., Bluetooth® 674 and/or Wi-Fi 672). At least one of the wireless modem(s) 670 is typically configured for communication with one or more cellular networks, such as a GSM network for data and voice communications within a single cellular network, between cellular networks, or between the mobile device and a public switched telephone network (PSTN).

The mobile device 600 may further include at least one input/output port 680, a power supply 682, a satellite navigation system receiver 684, such as a Global Positioning System (GPS) receiver, an accelerometer 686, and/or a physical connector 690, which may be a universal serial bus (USB) port, IEEE 1394 (FireWire) port, and/or RS-232 port. The illustrated components 602 are not required or all-inclusive, as any components may be deleted and other components may be added as would be recognized by one skilled in the art.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the AI-assisted security action logic 108, the AI-assisted security action logic 308, the source code management system 310, the file intent logic 314, the AI model 316, the mapping logic 318, the trigger logic 320, the information intent logic 322, the resource impact logic 324, the functionality determination logic 326, the extent determination logic 330, the satisfaction determination logic 332, the AI-assisted security action logic 508, the AI model 516, the impact determination logic 518, the trigger logic 520, the functionality determination logic 526, the type determination logic 528, the extent determination logic 530, the satisfaction determination logic 532, the intent determination logic 564, flowchart 200, and/or flowchart 400 may be implemented in hardware, software, firmware, or any combination thereof.

For example, any one or more of the AI-assisted security action logic 108, the AI-assisted security action logic 308, the source code management system 310, the file intent logic 314, the AI model 316, the mapping logic 318, the trigger logic 320, the information intent logic 322, the resource impact logic 324, the functionality determination logic 326, the extent determination logic 330, the satisfaction determination logic 332, the AI-assisted security action logic 508, the AI model 516, the impact determination logic 518, the trigger logic 520, the functionality determination logic 526, the type determination logic 528, the extent determination logic 530, the satisfaction determination logic 532, the intent determination logic 564, flowchart 200, and/or flowchart 400 may be implemented, at least in part, as computer program code configured to be executed in one or more processors.

In another example, any one or more of the AI-assisted security action logic 108, the AI-assisted security action logic 308, the source code management system 310, the file intent logic 314, the AI model 316, the mapping logic 318, the trigger logic 320, the information intent logic 322, the resource impact logic 324, the functionality determination logic 326, the extent determination logic 330, the satisfaction determination logic 332, the AI-assisted security action logic 508, the AI model 516, the impact determination logic 518, the trigger logic 520, the functionality determination logic 526, the type determination logic 528, the extent determination logic 530, the satisfaction determination logic 532, the intent determination logic 564, flowchart 200, and/or flowchart 400 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

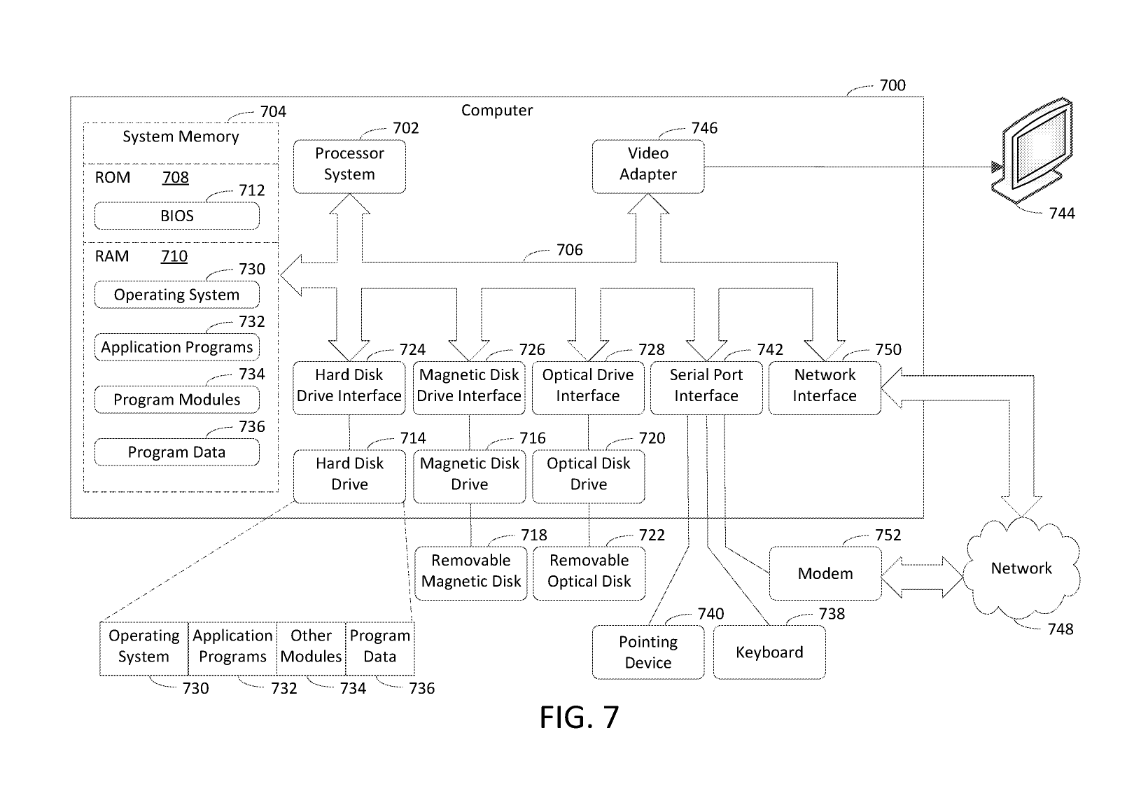

(A1) A first example system (FIG. 1, 102A-102M, 106A-106N; FIG. 3, 300; FIG. 6, 602; FIG. 7, 700) comprises a processor system (FIG. 6, 610; FIG. 7, 702) and a memory (FIG. 6, 620, 622, 624; FIG. 7, 704, 708, 710) that stores computer-executable instructions. The computer-executable instructions are executable by the processor system to at least receive (FIG. 2, 202) a security alert (FIG. 3, 334) regarding an identified resource in an information technology infrastructure of an enterprise. The computer-executable instructions are executable by the processor system further to at least determine (FIG. 2, 204) intents (FIG. 3, 336) of subsets of files (FIG. 3, 350) in a source code management system (FIG. 3, 310) regarding a software application that is utilized by the enterprise using an artificial intelligence (AI) model (FIG. 3, 316) by causing the AI model to analyze contents of the files. The computer-executable instructions are executable by the processor system further to at least map (FIG. 2, 206) the intents to subsets of resources in the information technology infrastructure based at least on a mapping (FIG. 3, 338) of the subsets of the files to the subsets of the resources. The computer-executable instructions are executable by the processor system further to at least, in response to the security alert, trigger (FIG. 2, 208) execution of an instruction, which causes a designated security action (FIG. 3, 360) to be performed with regard to the identified resource by selecting the designated security action from a plurality of security actions, as a result of an identified intent that is mapped to the identified resource satisfying an action criterion (FIG. 3, 340) associated with the designated security action.

(A2) In the example system of A1, wherein the computer-executable instructions are executable by the processor system to at least: determine second intents of subsets of information regarding the software application using the AI model by causing the AI model to analyze the information, the subsets of the information comprising at least one of subsets of documentation regarding the software application or subsets of communications regarding the software application; determine impacts of the subsets of the resources in the information technology infrastructure on the enterprise using the AI model by causing the AI model to analyze the subsets of the information based at least on the intents of the subsets of the resources corresponding to the second intents of the subsets of the information; and trigger the execution of the instruction as a result of the identified intent that is mapped to the identified resource satisfying the action criterion and further as a result of an identified impact of a subset of resources that comprises the identified resource satisfying a second action criterion associated with the designated security action.

(A3) In the example system of any of A1-A2, wherein the computer-executable instructions are executable by the processor system to at least: distinguish the files in the source code management system, which originate from within the enterprise, from second files in the source code management system, which originate from a source that is external to the enterprise, using a source code analysis technique; and determine the intents of the subsets of the files as a result of distinguishing the files from the second files.

(A4) In the example system of any of A1-A3, wherein the computer-executable instructions are executable by the processor system to at least: merge a first intent of a first subset of the files and a second intent of a second subset of the files to provide a combined intent of a combined subset of the files; and map the combined intent of the combined subset of the files to an identified subset of the resources, which is comprised in the subsets of the resources.

(A5) In the example system of any of A1-A4, wherein the computer-executable instructions are executable by the processor system to at least: determine a first intent of a first subset of the files by combining a plurality of sub-intents of a plurality of files in the first subset that are associated with respective sub-components of the software application; and map the first intent to a first subset of the resources in the information technology infrastructure based at least on the mapping of the subsets of the files to the subsets of the resources comprising a mapping of the first subset of the files to the first subset of the resources.

(A6) In the example system of any of A1-A5, wherein the computer-executable instructions are executable by the processor system to at least: determine a functionality of the software application in context of the enterprise; determine a type of the identified resource; determine the identified intent of a first subset of the files by taking into consideration the functionality of the software application and the type of the identified resource; and map the identified intent to a first subset of the resources that comprises the identified resource based at least on the mapping of the subsets of the files to the subsets of the resources comprising a mapping of the first subset of the files to the first subset of the resources.

(A7) In the example system of any of A1-A6, wherein the computer-executable instructions are executable by the processor system further to at least: determine a plurality of extents to which the plurality of security actions are capable of negative impacting customers of the enterprise by analyzing the identified intent that is mapped to the identified resource; and determine that the identified intent satisfies the action criterion by taking into consideration the extent to which the designated security action is capable of negatively impacting the customers of the enterprise.

(A8) In the example system of any of A1-A7, wherein the computer-executable instructions are executable by the processor system to at least: determine the intents of the subsets of the files using a graph retrieval-augmented generation technique.

(A9) In the example system of any of A1-A8, wherein the graph retrieval-augmented generation technique takes into consideration hierarchical relationships among the subsets of the files.

(A10) In the example system of any of A1-A9, wherein the computer-executable instructions are executable by the processor system further to at least: identify a first subset of the files by scanning a container image that is stored in the source code management system.

(B1) A second example system (FIG. 1, 102A-102M, 106A-106N; FIG. 5, 500; FIG. 6, 602; FIG. 7, 700) comprises a processor system (FIG. 6, 610; FIG. 7, 702) and a memory (FIG. 6, 620, 622, 624; FIG. 7, 704, 708, 710) that stores computer-executable instructions. The computer-executable instructions are executable by the processor system to at least receive (FIG. 4, 402) a security alert (FIG. 5, 534) regarding an identified resource in an information technology infrastructure of an enterprise. The computer-executable instructions are executable by the processor system further to at least determine (FIG. 4, 404) first intents (FIG. 5, 566) of subsets of information (FIG. 5, 552) regarding a software application that is utilized by the enterprise using an artificial intelligence (AI) model (FIG. 5, 516) by causing the AI model to analyze the information. The subsets of the information comprise at least one of subsets of documentation regarding the software application or subsets of communications regarding the software application. The computer-executable instructions are executable by the processor system further to at least determine (FIG. 4, 406) impacts (FIG. 5, 570) of subsets of resources in the information technology infrastructure on the enterprise using the AI model by causing the AI model to analyze the subsets of the information based at least on the first intents of the subsets of the information corresponding to second intents (FIG. 5, 568) of the subsets of the resources. The computer-executable instructions are executable by the processor system further to at least, in response to the security alert, trigger (FIG. 4, 408) execution of an instruction, which causes a designated security action (FIG. 5, 560) to be performed with regard to the identified resource by selecting the designated security action from a plurality of security actions, as a result of an identified impact of a subset of resources that comprises the identified resource satisfying an action criterion (FIG. 5, 540) associated with the designated security action.

(B2) In the example system of B1, wherein the computer-executable instructions are executable by the processor system further to at least: merge an intent of a first subset of the information and an intent of a second subset of the information to provide a combined intent of a combined subset of the information; and map the combined intent of the combined subset of the information to an identified subset of the resources, which is comprised in the subsets of the resources.

(B3) In the example system of any of B1-B2, wherein the computer-executable instructions are executable by the processor system to at least: determine a functionality of the software application in context of the enterprise; determine a type of the identified resource; determine a first intent of a first subset of the information by taking into consideration the functionality of the software application and the type of the identified resource; and determine the identified impact of the subset of the resources that comprises the identified resource based at least on the first intent of the first subset of the information corresponding to a second intent of the subset of the resources that comprises the identified resource.

(B4) In the example system of any of B1-B3, wherein the computer-executable instructions are executable by the processor system further to at least: determine a plurality of extents to which the plurality of security actions are capable of negative impacting customers of the enterprise by analyzing the identified impact of the subset of the resources that comprises the identified resource; and determine that the identified impact of the subset of the resources that comprises the identified resource satisfies the action criterion by taking into consideration the extent to which the designated security action is capable of negatively impacting the customers of the enterprise.

(B5) In the example system of any of B1-B4, wherein the computer-executable instructions are executable by the processor system to at least: determine the first intents of the subsets of the information using a graph retrieval-augmented generation technique.

(B6) In the example system of any of B1-B5, wherein the information regarding the software application comprises an electronic mail message regarding the software application; and wherein the computer-executable instructions are executable by the processor system to at least: derive the identified impact of the subset of the resources that comprises the identified resource from content of the electronic mail message.

(B7) In the example system of any of B1-B6, wherein the information regarding the software application comprises a specification that describes features of the software application; and wherein the computer-executable instructions are executable by the processor system to at least: derive the identified impact of the subset of the resources that comprises the identified resource from content of the specification that describes the features of the software application.

(B8) In the example system of any of B1-B7, wherein the information regarding the software application indicates attributes of users of the software application; and wherein the computer-executable instructions are executable by the processor system to at least: derive the identified impact of the subset of the resources that comprises the identified resource from the attributes of the users of the software application.

(B9) In the example system of any of B1-B8, wherein the identified impact of the subset of the resources that comprises the identified resource comprises an estimate of a number of users of the software application.

(C1) A first example method is implemented by a computing system (FIG. 1, 102A-102M, 106A-106N; FIG. 3, 300; FIG. 6, 602; FIG. 7, 700). The method comprises receiving (FIG. 2, 202) a security alert (FIG. 3, 334) regarding an identified resource in an information technology infrastructure of an enterprise. The method further comprises determining (FIG. 2, 204) intents (FIG. 3, 336) of subsets of files (FIG. 3, 350) in a source code management system (FIG. 3, 310) regarding a software application that is utilized by the enterprise using an artificial intelligence (AI) model (FIG. 3, 316) by causing the AI model to analyze contents of the files. The method further comprises mapping (FIG. 2, 206) the intents to subsets of resources in the information technology infrastructure based at least on a mapping (FIG. 3, 338) of the subsets of the files to the subsets of the resources. The method further comprises, in response to the security alert, triggering (FIG. 2, 208) execution of an instruction, which causes a designated security action (FIG. 3, 360) to be performed with regard to the identified resource by selecting the designated security action from a plurality of security actions, as a result of an identified intent that is mapped to the identified resource satisfying an action criterion (FIG. 3, 340) associated with the designated security action.

(C2) In the example method of C1, further comprising: determining second intents of subsets of information regarding the software application using the AI model by causing the AI model to analyze the information, the subsets of the information comprising at least one of subsets of documentation regarding the software application or subsets of communications regarding the software application; and determining impacts of the subsets of the resources in the information technology infrastructure on the enterprise using the AI model by causing the AI model to analyze the subsets of the information based at least on the intents of the subsets of the resources corresponding to the second intents of the subsets of the information; wherein execution of the instruction is triggered as a result of the identified intent that is mapped to the identified resource satisfying the action criterion and further as a result of an identified impact of a subset of resources that comprises the identified resource satisfying a second action criterion associated with the designated security action.

(C3) In the example method of any of C1-C2, further comprising: distinguishing the files in the source code management system, which originate from within the enterprise, from second files in the source code management system, which originate from a source that is external to the enterprise, using a source code analysis technique; wherein determining the intents of the subsets of the files comprises: determining the intents of the subsets of the files as a result of distinguishing the files from the second files.

(C4) In the example method of any of C1-C3, wherein mapping the intents to the subsets of the resources comprises: merging a first intent of a first subset of the files and a second intent of a second subset of the files to provide a combined intent of a combined subset of the files; and mapping the combined intent of the combined subset of the files to an identified subset of the resources, which is comprised in the subsets of the resources.

(C5) In the example method of any of C1-C4, wherein determining the intents of the subsets of the files comprises: determining a first intent of a first subset of the files by combining a plurality of sub-intents of a plurality of files in the first subset that are associated with respective sub-components of the software application; and wherein mapping the intents to the subsets of the resources comprises: mapping the first intent to a first subset of the resources in the information technology infrastructure based at least on the mapping of the subsets of the files to the subsets of the resources comprising a mapping of the first subset of the files to the first subset of the resources.

(C6) In the example method of any of C1-C5, further comprising: determining a functionality of the software application in context of the enterprise; and determining a type of the identified resource; wherein determining the intents of the subsets of the files comprises: determining the identified intent of a first subset of the files by taking into consideration the functionality of the software application and the type of the identified resource; and wherein mapping the intents to the subsets of the resources comprises: mapping the identified intent to a first subset of the resources that comprises the identified resource based at least on the mapping of the subsets of the files to the subsets of the resources comprising a mapping of the first subset of the files to the first subset of the resources.

(C7) In the example method of any of C1-C6, further comprising: determining a plurality of extents to which the plurality of security actions are capable of negative impacting customers of the enterprise by analyzing the identified intent that is mapped to the identified resource; and determining that the identified intent satisfies the action criterion by taking into consideration the extent to which the designated security action is capable of negatively impacting the customers of the enterprise.

(C8) In the example method of any of C1-C7, wherein determining the intents of the subsets of the files comprises: determining the intents of the subsets of the files using a graph retrieval-augmented generation technique.

(C9) In the example method of any of C1-C8, wherein the graph retrieval-augmented generation technique takes into consideration hierarchical relationships among the subsets of the files.

(C10) In the example method of any of C1-C9, further comprising: identifying a first subset of the files by scanning a container image that is stored in the source code management system.

(D1) A second example method is implemented by a computing system (FIG. 1, 102A-102M, 106A-106N; FIG. 5, 500; FIG. 6, 602; FIG. 7, 700). The method comprises receiving (FIG. 4, 402) a security alert (FIG. 5, 534) regarding an identified resource in an information technology infrastructure of an enterprise. The method further comprises determining (FIG. 4, 404) first intents (FIG. 5, 566) of subsets of information (FIG. 5, 552) regarding a software application that is utilized by the enterprise using an artificial intelligence (AI) model (FIG. 5, 516) by causing the AI model to analyze the information. The subsets of the information comprise at least one of subsets of documentation regarding the software application or subsets of communications regarding the software application. The method further comprises determining (FIG. 4, 406) impacts (FIG. 5, 570) of subsets of resources in the information technology infrastructure on the enterprise using the AI model by causing the AI model to analyze the subsets of the information based at least on the first intents of the subsets of the information corresponding to second intents (FIG. 5, 568) of the subsets of the resources. The method further comprises, in response to the security alert, triggering (FIG. 4, 408) execution of an instruction, which causes a designated security action (FIG. 5, 560) to be performed with regard to the identified resource by selecting the designated security action from a plurality of security actions, as a result of an identified impact of a subset of resources that comprises the identified resource satisfying an action criterion (FIG. 5, 540) associated with the designated security action.

(D2) In the example method of D1, further comprising: merging an intent of a first subset of the information and an intent of a second subset of the information to provide a combined intent of a combined subset of the information; and mapping the combined intent of the combined subset of the information to an identified subset of the resources, which is comprised in the subsets of the resources.

(D3) In the example method of any of D1-D2, further comprising: determining a functionality of the software application in context of the enterprise; and determining a type of the identified resource; wherein determining the first intents of the subsets of the information comprises: determining a first intent of a first subset of the information by taking into consideration the functionality of the software application and the type of the identified resource; and wherein determining the impacts of the subsets of the resources comprises: determining the identified impact of the subset of the resources that comprises the identified resource based at least on the first intent of the first subset of the information corresponding to a second intent of the subset of the resources that comprises the identified resource.

(D4) In the example method of any of D1-D3, further comprising: determining a plurality of extents to which the plurality of security actions are capable of negative impacting customers of the enterprise by analyzing the identified impact of the subset of the resources that comprises the identified resource; and determining that the identified impact of the subset of the resources that comprises the identified resource satisfies the action criterion by taking into consideration the extent to which the designated security action is capable of negatively impacting the customers of the enterprise.

(D5) In the example method of any of D1-D4, wherein determining the first intents of the subsets of the information comprises: determining the first intents of the subsets of the information using a graph retrieval-augmented generation technique.

(D6) In the example method of any of D1-D5, wherein the information regarding the software application comprises an electronic mail message regarding the software application; and wherein determining the impacts of the subsets of the resources comprises: deriving the identified impact of the subset of the resources that comprises the identified resource from content of the electronic mail message.

(D7) In the example method of any of D1-D6, wherein the information regarding the software application comprises a specification that describes features of the software application; and wherein determining the impacts of the subsets of the resources comprises: deriving the identified impact of the subset of the resources that comprises the identified resource from content of the specification that describes the features of the software application.

(D8) In the example method of any of D1-D7, wherein the information regarding the software application indicates attributes of users of the software application; and wherein determining the impacts of the subsets of the resources comprises: deriving the identified impact of the subset of the resources that comprises the identified resource from the attributes of the users of the software application.

(D9) In the example method of any of D1-D8, wherein the identified impact of the subset of the resources that comprises the identified resource comprises an estimate of a number of users of the software application.

(E1) A first example computer program product (FIG. 6, 624; FIG. 7, 718, 722) comprises a computer-readable storage medium having instructions recorded thereon for enabling a processor-based system (FIG. 1, 102A-102M, 106A-106N; FIG. 3, 300; FIG. 6, 602; FIG. 7, 700) to perform operations. The operations comprise determining (FIG. 2, 204) intents (FIG. 3, 336) of subsets of files (FIG. 3, 350) in a source code management system (FIG. 3, 310) regarding a software application that is utilized by an enterprise using an artificial intelligence (AI) model (FIG. 3, 316) by causing the AI model to analyze contents of the files. The operations further comprise mapping (FIG. 2, 206) the intents to subsets of resources in an information technology infrastructure of the enterprise based at least on a mapping (FIG. 3, 338) of the subsets of the files to the subsets of the resources. The operations further comprise, in response to a security alert (FIG. 3, 334) regarding an identified resource in the information technology infrastructure of the enterprise, triggering (FIG. 2, 208) execution of an instruction, which causes a designated security action to be performed with regard to the identified resource by selecting the designated security action from a plurality of security actions, as a result of an identified intent that is mapped to the identified resource satisfying an action criterion (FIG. 3, 340) associated with the designated security action.

(F1) A second example computer program product (FIG. 6, 624; FIG. 7, 718, 722) comprises a computer-readable storage medium having instructions recorded thereon for enabling a processor-based system (FIG. 1, 102A-102M, 106A-106N; FIG. 5, 500; FIG. 6, 602; FIG. 7, 700) to perform operations. The operations comprise determining (FIG. 4, 404) first intents (FIG. 5, 566) of subsets of information (FIG. 5, 552) regarding a software application that is utilized by the enterprise using an artificial intelligence (AI) model (FIG. 5, 516) by causing the AI model to analyze the information. The subsets of the information comprise at least one of subsets of documentation regarding the software application or subsets of communications regarding the software application. The operations further comprise determining (FIG. 4, 406) impacts (FIG. 5, 570) of subsets of resources in the information technology infrastructure on the enterprise using the AI model by causing the AI model to analyze the subsets of the information based at least on the first intents of the subsets of the information corresponding to second intents (FIG. 5, 568) of the subsets of the resources. The operations further comprise, in response to a security alert (FIG. 5, 534) regarding an identified resource in the information technology infrastructure of the enterprise, triggering (FIG. 4, 408) execution of an instruction, which causes a designated security action (FIG. 5, 560) to be performed with regard to the identified resource by selecting the designated security action from a plurality of security actions, as a result of an identified impact of a subset of resources that comprises the identified resource satisfying an action criterion (FIG. 5, 540) associated with the designated security action.

### III. Example Computer System

FIG. 7 depicts an example computer 700 in which embodiments may be implemented. Any one or more of the user devices 102A-102M and/or any one or more of the servers 106A-106N shown in FIG. 1, the computing system 300 shown in FIG. 3, and/or the computing system 500 shown in FIG. 5 may be implemented using computer 700, including one or more features of computer 700 and/or alternative features. Computer 700 may be a general-purpose computing device in the form of a conventional personal computer, a mobile computer, or a workstation, for example, or computer 700 may be a special purpose computing device. The description of computer 700 provided herein is provided for purposes of illustration, and is not intended to be limiting. Embodiments may be implemented in further types of computer systems, as would be known to persons skilled in the relevant art(s).

As shown in FIG. 7, computer 700 includes a processor system 702, a system memory 704, and a bus 706 that couples various system components including system memory 704 to processor system 702. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computer 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 730, one or more application programs 732, other program modules 734, and program data 736. Application programs 732 or program modules 734 may include, for example, computer program logic for implementing any one or more of (e.g., at least a portion of) the AI-assisted security action logic 108, the AI-assisted security action logic 308, the source code management system 310, the file intent logic 314, the AI model 316, the mapping logic 318, the trigger logic 320, the information intent logic 322, the resource impact logic 324, the functionality determination logic 326, the extent determination logic 330, the satisfaction determination logic 332, the AI-assisted security action logic 508, the AI model 516, the impact determination logic 518, the trigger logic 520, the functionality determination logic 526, the type determination logic 528, the extent determination logic 530, the satisfaction determination logic 532, the intent determination logic 564, flowchart 200 (including any step of flowchart 200), and/or flowchart 400 (including any step of flowchart 400), as described herein.

A user may enter commands and information into the computer 700 through input devices such as keyboard 738 and pointing device 740. Other input devices (not shown) may include a microphone, joystick, game pad, satellite dish, scanner, touch screen, camera, accelerometer, gyroscope, or the like. These and other input devices are often connected to the processor system 702 through a serial port interface 742 that is coupled to bus 706, but may be connected by other interfaces, such as a parallel port, game port, or a universal serial bus (USB).

A display device 744 (e.g., a monitor) is also connected to bus 706 via an interface, such as a video adapter 746. In addition to display device 744, computer 700 may include other peripheral output devices (not shown) such as speakers and printers.

Computer 700 is connected to a network 748 (e.g., the Internet) through a network interface or adapter 750, a modem 752, or other means for establishing communications over the network. Modem 752, which may be internal or external, is connected to bus 706 via serial port interface 742.

As used herein, the terms “computer program medium” and “computer-readable storage medium” are used to generally refer to media (e.g., non-transitory media) such as the hard disk associated with hard disk drive 714, removable magnetic disk 718, removable optical disk 722, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 732 and other program modules 734) may be stored on the hard disk, magnetic disk, optical disk, ROM, or RAM. Such computer programs may also be received via network interface 750 or serial port interface 742. Such computer programs, when executed or loaded by an application, enable computer 700 to implement features of embodiments discussed herein. Accordingly, such computer programs represent controllers of the computer 700.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
receive a security alert regarding an identified resource in an information technology infrastructure of an enterprise;
determine intents of subsets of files in a source code management system regarding a software application that is utilized by the enterprise using an artificial intelligence (AI) model by causing the AI model to analyze contents of the files;
map the intents to subsets of resources in the information technology infrastructure based at least on a mapping of the subsets of the files to the subsets of the resources; and
in response to the security alert, trigger execution of an instruction, which causes a designated security action to be performed with regard to the identified resource by selecting the designated security action from a plurality of security actions, as a result of an identified intent that is mapped to the identified resource satisfying an action criterion associated with the designated security action.

2. The system of claim 1, wherein the computer-executable instructions are executable by the processor system to at least:
determine second intents of subsets of information regarding the software application using the AI model by causing the AI model to analyze the information, the subsets of the information comprising at least one of subsets of documentation regarding the software application or subsets of communications regarding the software application;
determine impacts of the subsets of the resources in the information technology infrastructure on the enterprise using the AI model by causing the AI model to analyze the subsets of the information based at least on the intents of the subsets of the resources corresponding to the second intents of the subsets of the information; and
trigger the execution of the instruction as a result of the identified intent that is mapped to the identified resource satisfying the action criterion and further as a result of an identified impact of a subset of resources that comprises the identified resource satisfying a second action criterion associated with the designated security action.

3. The system of claim 1, wherein the computer-executable instructions are executable by the processor system to at least:
distinguish the files in the source code management system, which originate from within the enterprise, from second files in the source code management system, which originate from a source that is external to the enterprise, using a source code analysis technique; and
determine the intents of the subsets of the files as a result of distinguishing the files from the second files.

4. The system of claim 1, wherein the computer-executable instructions are executable by the processor system to at least:
merge a first intent of a first subset of the files and a second intent of a second subset of the files to provide a combined intent of a combined subset of the files; and
map the combined intent of the combined subset of the files to an identified subset of the resources, which is comprised in the subsets of the resources.

5. The system of claim 1, wherein the computer-executable instructions are executable by the processor system to at least:
determine a first intent of a first subset of the files by combining a plurality of sub-intents of a plurality of files in the first subset that are associated with respective sub-components of the software application; and
map the first intent to a first subset of the resources in the information technology infrastructure based at least on the mapping of the subsets of the files to the subsets of the resources comprising a mapping of the first subset of the files to the first subset of the resources.

6. The system of claim 1, wherein the computer-executable instructions are executable by the processor system to at least:
determine a functionality of the software application in context of the enterprise;
determine a type of the identified resource;
determine the identified intent of a first subset of the files by taking into consideration the functionality of the software application and the type of the identified resource; and
map the identified intent to a first subset of the resources that comprises the identified resource based at least on the mapping of the subsets of the files to the subsets of the resources comprising a mapping of the first subset of the files to the first subset of the resources.

7. The system of claim 1, wherein the computer-executable instructions are executable by the processor system further to at least:
determine a plurality of extents to which the plurality of security actions are capable of negative impacting customers of the enterprise by analyzing the identified intent that is mapped to the identified resource; and
determine that the identified intent satisfies the action criterion by taking into consideration the extent to which the designated security action is capable of negatively impacting the customers of the enterprise.

8. The system of claim 1, wherein the computer-executable instructions are executable by the processor system to at least:
determine the intents of the subsets of the files using a graph retrieval-augmented generation technique.

9. The system of claim 8, wherein the graph retrieval-augmented generation technique takes into consideration hierarchical relationships among the subsets of the files.

10. The system of claim 1, wherein the computer-executable instructions are executable by the processor system further to at least:
identify a first subset of the files by scanning a container image that is stored in the source code management system.

11. A method implemented by a computing system, the method comprising:
receiving a security alert regarding an identified resource in an information technology infrastructure of an enterprise;
determining first intents of subsets of information regarding a software application that is utilized by the enterprise using an artificial intelligence (AI) model by causing the AI model to analyze the information, the subsets of the information comprising at least one of subsets of documentation regarding the software application or subsets of communications regarding the software application;
determining impacts of subsets of resources in the information technology infrastructure on the enterprise using the AI model by causing the AI model to analyze the subsets of the information based at least on the first intents of the subsets of the information corresponding to second intents of the subsets of the resources; and
in response to the security alert, triggering execution of an instruction, which causes a designated security action to be performed with regard to the identified resource by selecting the designated security action from a plurality of security actions, as a result of an identified impact of a subset of resources that comprises the identified resource satisfying an action criterion associated with the designated security action.

12. The method of claim 11, further comprising:
merging an intent of a first subset of the information and an intent of a second subset of the information to provide a combined intent of a combined subset of the information; and
mapping the combined intent of the combined subset of the information to an identified subset of the resources, which is comprised in the subsets of the resources.

13. The method of claim 11, further comprising:
determining a functionality of the software application in context of the enterprise; and
determining a type of the identified resource;
wherein determining the first intents of the subsets of the information comprises:
determining a first intent of a first subset of the information by taking into consideration the functionality of the software application and the type of the identified resource; and
wherein determining the impacts of the subsets of the resources comprises:
determining the identified impact of the subset of the resources that comprises the identified resource based at least on the first intent of the first subset of the information corresponding to a second intent of the subset of the resources that comprises the identified resource.

14. The method of claim 11, further comprising:
determining a plurality of extents to which the plurality of security actions are capable of negative impacting customers of the enterprise by analyzing the identified impact of the subset of the resources that comprises the identified resource; and
determining that the identified impact of the subset of the resources that comprises the identified resource satisfies the action criterion by taking into consideration the extent to which the designated security action is capable of negatively impacting the customers of the enterprise.

15. The method of claim 11, wherein determining the first intents of the subsets of the information comprises:
determining the first intents of the subsets of the information using a graph retrieval-augmented generation technique.

16. The method of claim 11, wherein the information regarding the software application comprises an electronic mail message regarding the software application; and
wherein determining the impacts of the subsets of the resources comprises:
deriving the identified impact of the subset of the resources that comprises the identified resource from content of the electronic mail message.

17. The method of claim 11, wherein the information regarding the software application comprises a specification that describes features of the software application; and
wherein determining the impacts of the subsets of the resources comprises:
deriving the identified impact of the subset of the resources that comprises the identified resource from content of the specification that describes the features of the software application.

18. The method of claim 11, wherein the information regarding the software application indicates attributes of users of the software application; and
wherein determining the impacts of the subsets of the resources comprises:
deriving the identified impact of the subset of the resources that comprises the identified resource from the attributes of the users of the software application.

19. The method of claim 11, wherein the identified impact of the subset of the resources that comprises the identified resource comprises an estimate of a number of users of the software application.

20. A computer program product comprising a computer-readable storage medium having instructions recorded thereon for enabling a processor-based system to perform operations, the operations comprising:
determining intents of subsets of files in a source code management system regarding a software application that is utilized by an enterprise using an artificial intelligence (AI) model by causing the AI model to analyze contents of the files;
mapping the intents to subsets of resources in an information technology infrastructure of the enterprise based at least on a mapping of the subsets of the files to the subsets of the resources; and
in response to a security alert regarding an identified resource in the information technology infrastructure of the enterprise, triggering execution of an instruction, which causes a designated security action to be performed with regard to the identified resource by selecting the designated security action from a plurality of security actions, as a result of an identified intent that is mapped to the identified resource satisfying an action criterion associated with the designated security action.
